(19) United States
(12) Patent Application Publication
(10) Pub. No.: US 2006/0256803 A1
(43) Pub. Date: Nov. 16, 2006

(54) Communication method

(76) Inventors: Tsuneo Nakata, Tokyo (JP); Masahiro Ono, Tokyo (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/526,959

(22) PCT Filed: Jan. 7, 2005
(86) PCT No.: PCT/JP05/00124

§ 371 Date: Jun. 21, 2006

(30) Foreign Application Priority Data
Jan. 9, 2004 (JP) 2004-004795
Sep. 7, 2004 (JP) 2004-260332

(51) Int. Cl. H04L 12/56

(52) U.S. Cl. 370/412

(57) ABSTRACT

A first identifier for identifying each flow belonging to a first group relating to a sequencing, a first sequential number, said first sequential number being unique within each flow of the first group flow, a second identifier for identifying a flow relating to a retransmitting control, and a second sequential number, said second sequential number being unique within each flow belonging to the second group flow, are affixed to a transmission packet to transmit it. A receiving node makes a request for retransmission based upon the second identifier and the second sequential number, and a transmitting node retransmits its packet. Also, in the sequencing of the packets, the receiving node takes a sequencing of the packet based upon the first identifier and the first sequential number.

### APPLICABLE FIELD IN THE INDUSTRY

The present invention relates to a packet communication between the two nodes in which a flow exists, and more particularly to a retransmitting control.

### BACKGROUND ART

In a case where two nodes make packet communication over an internet, a packet loss and a packet sequence error occur. As a method of coping with the packet loss, a technology of a retransmitting method of the packet has been proposed (for example, a patent document 1). In the technology of the patent document 1, a flow control and a sequencing of the transmission packet are taken between a transmitting node and a receiving node; however in a case a wait for sequence occurred in the receiving node due to the packet loss, if the packet, which was an object of a wait for sequence, was not received within a fixed time, the transmitting node is notified of a request for retransmitting the packet which is an object of a wait for sequence.

Also, in a case where a plurality of flows exist between two nodes, the retransmission and the sequencing of the packet were made with each flow assumed to be a unit, by employing, for example, a TCP (“Transmission Control Protocol”, rfc793) or the like.

The sequencing and the retransmitting control accompanied by a detection of the packet loss according to the prior art will be explained below, by employing FIG. 19.

FIG. 19 shows a detection of the packet loss in a case of transmitting packets from three flows of a flow 1, a flow 2, and a flow 3 via one path.

According to FIG. 19, a packet 1-1, a packet 1-2, and a packet 1-3 are received from the flow 1, a packet 2-1, a packet 2-2 and a packet 2-3 are received from the flow 2, and a packet 3-1, a packet 3-2 and a packet 3-3 are received from the flow 3, respectively. Additionally, identification information indicating a flow and an order (sequential number) of the packet of each flow are affixed to each packet. For example, the packet 2-2 indicates that it stands in the second order of the flow 2.

In transmitting the received packets to one path 4, the packets are sequentially selected one by one from each flow and transmitted to the path 4. That is, the packets are transmitted to the path 4 in the order of the packet 1-1, the packet 2-1, the packet 3-1, . . . , the packet 1-3, the packet 2-3 and the packet 3-3. On the receiving side, the sequencing is taken of putting the packets received from the path 4 in order flow by flow again based upon identification information of the packet, and the lost packets are detected, thereby to make a request for retransmission (regenerating control).

The patent document 1: JP-P1997-46375A

### DISCLOSURE OF THE INVENTION

### Problems to be Solved by the Invention

The prior art, however, had the problem that a detection of the packet loss was delayed because a detection of the packet loss was made while the sequencing was taken, notwithstanding transmission/reception of many packets.

For example, in the prior art shown in FIG. 19, upon thinking that a loss of the packet 2-2 occurred on the path 4, it follows that the receiving side receives the packets in the order of the packet 1-1, the packet 2-1, the packet 3-1, . . . , the packet 1-3, the packet 2-3 and the packet 3-3 because it receives the packets in the transmitting order. The lost packet is the packet 2-2, so the packet, which is to be received next to the packet 1-2, is the packet 3-2.

At this time point, it is impossible to detect that the packet 2-2 was lost, and only after the next packet 2-3 belonging to a flow identical to that of the lost packet 2-2 is received and sequenced to detect the packet 2-1 and the packet 2-3, a loss of the packet 2-2 is detected. That is, in an example of FIG. 19, a loss of the packet 2-2 can be detected only after waiting for the reception and the sequencing of the packet 2-3 which is three packets behind the lost packet 2-2.

Thereupon, the present invention has been accomplished in consideration of the above-mentioned problems, and an object thereof is to solve the above-mentioned problems and to provide a technology for allowing the packet loss to be detected at an earlier stage as compared with the conventional retransmitting control per flow.

Also, an object of the present invention is to solve the above-mentioned problems and to provide a technology for allowing the packet loss to be detected at an earlier stage as compared with the conventional detection of the packet loss.

Also, an object of the present invention is to provide a technology for allowing the packet to be detected at an earlier stage for controlling the retransmission, by affixing to the packet identification information for a loss detection and a regenerating control of the packet apart from identification information for a sequencing, thereby to independently carry out a sequencing, a detection of the packet loss, and a regenerating control.

### Means to Solve the Problem

The first invention for solving the above-mentioned problems, which is a method of communication between a transmitting node and a receiving node, is characterized in that:

the transmitting node provides a first group flow having one flow or more based upon a first criterion relating to a sequencing and a second group flow having one flow or more based upon a second criterion relating to a retransmitting control, assigns a first identifier to each flow belonging to said first group flow group, said first identifier being unique, and assigns a second identifier to each flow belonging to said second group flow, said second identifier being unique; and

the transmitting node classifies the packets, which were input, into one flow or more belonging to said first group flow, based upon said first criterion, yet classifies them into one flow or more belonging to said second group flow, based upon said second criterion, affixes to said packets said first identifier, a first sequential number, said first sequential number being unique within flows specified by said first identifier, said second identifier, a second sequential number, said second sequential number being unique within flows specified by said second identifier, and transmit them;

the receiving node classifies all received packets based upon the second identifier, checks the packets having the second sequential number, which were not received, with each second group flow, and requests the transmitting node of retransmission thereof;

the transmitting node retransmits the packets of the second group flow having the second sequential number requested by the receiving node; and

the receiving node classifies all received packets based upon the first identifier, sequences the packets within each first group flow based upon the first sequential number, and performs a receiving process of the sequenced packets in the sequenced order.

The second invention for solving the above-mentioned problems is characterized in that in the above-mentioned first invention, the transmitting node and the receiving node are connected via one communicating path, the second group flow of the transmitting node is comprised of a single flow, and the packets are transmitted by utilizing a single communicating path.

The third invention for solving the above-mentioned problems is characterized in that in the above-mentioned first invention, in a case where a plurality of communicating paths for transmitting the packet exist, the transmitting node selects the communicating path for transmitting the packet, based upon a third criterion relating to a schedule of the packet transmission.

The fourth invention for solving the above-mentioned problems is characterized in that in the above-mentioned third invention, the transmitting node and the receiving node are connected via a plurality of communicating paths, and the transmitting node classifies the packets into unique flows corresponding to the communicating paths, through which the packets to be transmitted pass, as a second criterion, and selects the communicating path in retransmitting the packets independently of the communicating path selected at the time of the first transmission as a third criterion.

The fifth invention for solving the above-mentioned problems is characterized in that in the above-mentioned third invention, the transmitting node and the receiving node are connected via a plurality of communicating paths, and the transmitting node classifies the packets into the flows of which the number is fewer than the number of the communicating paths, through which the packets to be transmitted pass, as a second criterion, and selects the communicating path in retransmitting the packets independently of the communicating path selected at the time of the first transmission as a third criterion.

The sixth invention for solving the above-mentioned problems is characterized in that in one of the above-mentioned first invention to third invention, the transmitting node is a transmitting-side transferring node for transferring the packet, transmitted by a separate communicating node, and the receiving node is a receiving-side transferring node for transferring the packet, received by a separate communicating node.

The seventh invention for solving the above-mentioned problems is characterized in that in the above-mentioned sixth invention, the transmitting node and the receiving node are connected via one communicating path, the second group flow of the transmitting node is comprised of a single flow, and the packets are transmitted by utilizing a single communicating path.

The eighth invention for solving the above-mentioned problems is characterized in that in the above-mentioned sixth invention, the transmitting node and the receiving node are connected via a plurality of communicating paths, and the transmitting node classifies the packets into unique flows corresponding to the communicating paths, through which the packets to be transmitted pass, as a second criterion, and selects the communicating path in retransmitting the packet independently of the communicating path selected at the time of the first transmission as a third criterion.

The ninth invention for solving the above-mentioned problems is characterized in that in the above-mentioned sixth invention, the transmitting node and the receiving node are connected via a plurality of communicating paths, and the transmitting node classifies the packets into the flows of which the number is fewer than the number of the communicating paths, through which the packets to be transmitted pass, as a second criterion, and selects the communicating path in retransmitting the packet independently of the communicating path selected at the time of the first transmission as a third criterion.

The tenth invention for solving the above-mentioned problems is characterized in that selection of the path or a decision of a selection priority thereof is made in the transmitting node as a third criterion of the transmitting node, where path selection or path selection priority update is performed upon every packet to be input, based on path status information on a selectable path, based on identification information on a time from which said path status information is effective or on a transmitted packet, and based on a transmission history after the time from which said path status information is effective or a transmission history after transmission of the packet specified with transmitted packet identification information.

The eleventh invention for solving the above-mentioned problems is characterized in that in the above-mentioned tenth invention, said path status information includes a delay of a path.

The twelfth invention for solving the above-mentioned problems is characterized in that in one of the above-mentioned tenth invention and eleventh invention, said path status information includes a transmission rate of a path.

The thirteenth invention for solving the above-mentioned problems is characterized in that in one of the above-mentioned tenth invention to twelfth invention, said path status information includes a load of a path.

The fourteenth invention for solving the above-mentioned problems is characterized in that in one of the above-mentioned tenth invention to thirteenth invention, the communication method further comprising the step of correcting a transmission cost calculation result regarding a packet transmitted before updating path status information of each path, when the path status information is updated for path selection or selection priority update.

The fifteenth invention for solving the above-mentioned problems is characterized in that in one of the above-mentioned tenth invention to fourteen invention, the communication method further comprising the step of discarding a history prior to a first packet transmitted on or after a time from which the latest path status information is effective, when a transmission cost calculation result of each path is corrected.

The sixteenth invention for solving the above-mentioned problems is characterized in that in one of the above-mentioned tenth invention to fifteenth invention, the communication method further comprising the step of selecting as a packet transmission path a path having an earliest estimation value of a reception completion time at a reception node.

The seventeenth invention for solving the above-mentioned problems is characterized in that in one of the above-mentioned tenth invention to sixteenth invention, the communication method further comprising the step of selecting as a packet transmission path a path having a largest estimation value of a data amount, which can be completely received by a specific time at a reception node.

The eighteenth invention for solving the above-mentioned problems is characterized in that in one of the above-mentioned tenth invention to seventeenth invention, the communication method further the step of interrupting data transmission according to an estimated current path status in each path.

The nineteenth invention for solving the above-mentioned problems is characterized in that in the above-mentioned eighteenth invention, a condition for interruption of said data transmission is that an estimated reception completion time is equal to or greater than a specific value.

The twentieth invention for solving the above-mentioned problems is characterized in that in one of the above-mentioned tenth invention to nineteenth invention, path selection or a determination of a transmission interruption is made according to the policy, which differs every attribution of transmission data.

The twenty-first invention for solving the above-mentioned problems, which is a node, said node being configured of a transmitting section for transmitting a packet and a receiving section for receiving the packet and taking a retransmitting control and a sequencing of the packet independently, is characterized in that:

said transmitting section includes:

a means for affixing to the transmission packet a first identifier, said first identifier being assigned in a one-to-one manner to each flow of a first group flow based upon a first criterion relating to a sequencing, a first sequential number, said first sequential number being unique within each flow belonging to said first group flow, a second identifier, said second identifier being assigned in a one-to-one manner to each flow of a second group flow based upon a second criterion relating to a retransmitting control, and a second sequential number, said second sequential number being unique within each flow belonging to said second group flow, to transmit it; and

a means for specifying the packet, for which retransmission was requested by the node having received the packet, from said second identifier and second sequential number to retransmit its packet: and that

said receiving section includes:

a means for classifying all received packets based upon said second identifier to check the packets having the second sequential number, which were not received, with each second group flow to retransmit its second identifier and second sequential number to the node having transmitted the packet, and to request retransmission thereof; and

a means for classifying all received packets based upon said first identifier to sequence the packets within each first group flow based upon said first sequential number to perform a receiving process of the sequenced packets in the sequenced order.

The twenty-second invention for solving the above-mentioned problems is characterized in that in the above-mentioned twenty-first invention, each of nodes is connected to the other via one communicating path, the second group flow is comprised of a single flow, and the packet is transmitted by utilizing a single communicating path.

The twenty-third invention for solving the above-mentioned problems is characterized in that in the above-mentioned twenty-first invention, in a case where a plurality of communicating paths for transmitting the packet exist, it includes a means for selecting the communicating path for transmitting the packet, based upon a third criterion relating to a schedule of the packet transmission.

The twenty-fourth invention for solving the above-mentioned problems is characterized in that in the above-mentioned twenty-third invention, each of the nodes is connected to the other via a plurality of communicating paths, and the packets are classified into unique flows corresponding to the communicating paths, through which the packets to be transmitted pass, as a second criterion, and the communicating path is selected in retransmitting the packets independently of the communicating path selected at the time of the first transmission as a third criterion.

The twenty-fifth invention for solving the above-mentioned problems is characterized in that in the above-mentioned twenty-third invention, each of the nodes is connected to the other via a plurality of communicating paths, the packets are classified into the flows of which the number is fewer than the number of the communicating paths, through which the packets to be transmitted pass, as a second criterion, and the communicating path is selected in retransmitting the packets independently of the communicating path selected at the time of the first transmission as a third criterion.

The twenty-sixth invention for solving the above-mentioned problems is characterized in that in one of the above-mentioned twenty-first invention to twenty-third invention, the transmitting section of the node is a transmitting-side transferring node for transferring the packet transmitted by a separate communicating node, and the receiving section of the node is a receiving-side transferring node for transferring the packet received by a separate communicating node.

The twenty-seventh invention for solving the above-mentioned problems is characterized in that in the above-mentioned twenty-sixth invention, each of the nodes is connected to the other via one communicating path, the second group flow is comprised of a single flow, and the packets are transmitted by utilizing a single communicating path.

The twenty-eighth invention for solving the above-mentioned problems is characterized in that in the above-mentioned twenty-sixth invention, each of the nodes is connected to the other via a plurality of communicating paths, the packets are classified into unique flows corresponding to the communicating path, through which the packets to be transmitted pass, as a second criterion, and the communicating path is selected in retransmitting the packets independently of the communicating path selected at the time of the first transmission as a third criterion.

The twenty-ninth invention for solving the above-mentioned problems is characterized in that in the above-mentioned twenty-sixth invention, each of the nodes is connected to the other via a plurality of communicating paths, the packets are classified into the flows of which the number is fewer than the number of the communicating paths, through which the packets to be transmitted pass, as a second criterion, and the communicating path is selected in retransmitting the packets independently of the communicating path selected at the time of the first transmission as a third criterion.

The thirtieth invention for solving the above-mentioned problems is characterized in that in the above-mentioned twenty-third invention, said means for selecting the communicating path makes selection of the path or a decision of a selection priority thereof is made in the transmitting node as a third criterion, where path selection or path selection priority update is performed upon every packet to be input, based on path status information on a selectable path, based on identification information on a time from which said path status information is effective or on a transmitted packet, and based on a transmission history after the time from which said path status information is effective or a transmission history after transmission of the packet specified with transmitted packet identification information.

The thirty-first invention for solving the above-mentioned problems is characterized in that in the above-mentioned thirtieth invention, said path status information includes a delay of a path.

The thirty-second invention for solving the above-mentioned problems is characterized in that in the above-mentioned thirty-first invention, said path status information includes a transmission rate of a path.

The thirty-third invention for solving the above-mentioned problems is characterized in that in one of the above-mentioned thirtieth invention to thirty-second invention, said path status information includes a load of a path.

The thirty-fourth invention for solving the above-mentioned problems is characterized in that in one of the above-mentioned thirtieth invention to thirty-third invention, said means for selecting the communicating path corrects a transmission cost calculation result regarding a packet transmitted prior or updating when path status information of each path is updated in the updating of path selection or selection priority.

The thirty-fifth invention for solving the above-mentioned problems is characterized in that in one of the above-mentioned thirtieth invention to thirty-fourth invention, said means for selecting the communicating path discards a history before a first transmitted packet validating latest path status information when a transmission cost calculation result of each path is corrected.

The thirty-sixth invention for solving the above-mentioned problems is characterized in that in one of the above-mentioned thirtieth invention to thirty-fifth invention, said means for selecting the communicating path selects as a packet transmission path a path having an earliest estimation value of a reception completion time at a reception node.

The thirty-seventh invention for solving the above-mentioned problems is characterized in that in one of the above-mentioned thirtieth invention to thirty-sixth invention, said means for selecting the communicating path selects as a packet transmission path a path having a largest estimation value of a data amount which can be completely received by a specific time at a reception node.

The thirty-eighth invention for solving the above-mentioned problems is characterized in that in one of the above-mentioned thirtieth invention to thirty-seventh invention, said means for selecting the communicating path interrupts data transmission according to an estimated current path status for each path.

The thirty-ninth invention for solving the above-mentioned problems is characterized in that in the above-mentioned thirty-eighth invention, a condition for interruption of said data transmission is that an estimated reception completion time is equal to or greater than a specific value.

The fortieth invention for solving the above-mentioned problems is characterized in that in one of the above-mentioned thirtieth invention to thirty-ninth invention, said means for selecting the communicating path determines the interruption of path selection or transmission according to a policy different every attribute of a transmission data.

The forty-first invention for solving the above-mentioned problems, which is a controlling program for a node, said node taking a retransmitting control and a sequencing of a packet independently, is characterized in that said controlling program causes said node to function as:

a means for affixing to the transmission packet a first identifier, said first identifier being assigned in a one-to-one manner to each flow of a first group flow based upon a first criterion relating to a sequencing, a first sequential number, said first sequential number being unique within each flow belonging to said first group flow, a second identifier, said second identifier being assigned in a one-to-one manner to each flow of a second group flow based upon a second criterion relating to a retransmitting control, and a second sequential number, said second sequential number being unique within each flow belonging to said second group flow, to transmit it;

a means for specifying the packet, for which retransmission was requested by the node having received the packet, from said second identifier and second sequential number to retransmit its packet;

a means for classifying all received packets based upon said second identifier to check the packets having the second sequential number, which were not received, with each second group flow to transmit its second identifier and second sequential number to the node having transmitted the packet, and to request retransmission thereof; and

a means for classifying all received packets based upon said first identifier to sequence the packets based upon said first sequential number with each first group flow, and to perform a receiving process of the sequenced packets in the sequenced order.

The forty-second invention for solving the above-mentioned problems is characterized in that in the above-mentioned forty-first invention, each of the nodes is connected to the other via one communicating path, the second group flow is comprised of a single flow, and the packet is transmitted by utilizing a single communicating path.

The forty-third invention for solving the above-mentioned problems is characterized in that in the above-mentioned forty-first invention, in a case where a plurality of communicating paths for transmitting the packet exist, said controlling program causes said node to further function as a means for selecting the communicating path for transmitting the packet based upon a third criterion relating to a schedule of the packet transmission.

The forty-fourth invention for solving the above-mentioned problems is characterized in that in the above-mentioned forty-third invention, each of the nodes is connected to the other via a plurality of communicating paths, and the packets are classified into unique flows corresponding to the communicating paths, through which the packets to be transmitted pass, as a second criterion, and the communicating path is selected in retransmitting the packets independently of the communicating path selected at the time of the first transmission as a third criterion.

The forty-fifth invention for solving the above-mentioned problems is characterized in that in the above-mentioned forty-third invention, each of the nodes is connected to the other via a plurality of communicating paths, the packets are classified into the flows of which the number is fewer than the number of the communicating paths, through which the packets to be transmitted pass, as a second criterion, and the communicating path is selected in retransmitting the packets independently of the communicating path selected at the time of the first transmission as a third criterion.

The forty-sixth invention for solving the above-mentioned problems is characterized in that in one of the above-mentioned forty-first invention and forty-third invention, the transmitting section of the node is a transmitting-side transferring node for transferring the packet, transmitted by a separate communicating node, and the receiving section of the node is a receiving-side transferring node for transferring the packet, received by a separate communicating node.

The forty-seventh invention for solving the above-mentioned problems is characterized in that in the above-mentioned forty-sixth invention, each of the nodes is connected to the other via one communicating path, the second group flow is comprised of a single flow, and the packets are transmitted by utilizing a single communicating path.

The forty-eighth invention for solving the above-mentioned problems is characterized in that in the above-mentioned forty-sixth invention, each of the nodes is connected to the other via a plurality of communicating paths, the packets are classified into unique flows corresponding to the communicating paths, through which the packets to be transmitted pass, as a second criterion, and the communicating path is selected in retransmitting the packets independently of the communicating path selected at the time of the first transmission as a third criterion.

The forty-ninth invention for solving the above-mentioned problems is characterized in that in the above-mentioned forty-sixth invention, each of the nodes is connected to the other via a plurality of communicating paths, the packets are classified into the flows of which the number is fewer than the number of the communicating paths, through which the packets to be transmitted pass, as a second criterion, and the communicating path is selected in retransmitting the packets independently of the communicating path selected at the time of the first transmission as a third criterion.

The fiftieth invention for solving the above-mentioned problems is characterized in that in the above-mentioned forty-third invention, said controlling program causes said means for selecting the communicating path to make selection of the path or a decision of a selection priority thereof is made in the transmitting node as a third criterion, where path selection or path selection priority update is performed upon every packet to be input, based on path status information on a selectable path, based on identification information on a time from which said path status information is effective or on a transmitted packet, and based on a transmission history after the time from which said path status information is effective or a transmission history after transmission of the packet specified with transmitted packet identification information.

The fifty-first invention for solving the above-mentioned problems is characterized in that in the above-mentioned fiftieth invention, said path status information includes a delay of a path.

The fifty-second invention for solving the above-mentioned problems is characterized in that in one of the above-mentioned fiftieth invention and fifty-first invention, said path status information includes a transmission rate of a path.

The fifty-third invention for solving the above-mentioned problems is characterized in that in one of the above-mentioned fiftieth invention to fifty-second invention, said path status information includes a load of a path.

The fifty-fourth invention for solving the above-mentioned problems is characterized in that in one of the above-mentioned fiftieth invention to fifty-third invention, the controlling problems further controls said means for selecting the communicating path so as to correct a transmission cost calculation result regarding a packet transmitted prior or updating when path status information of each path is updated in the updating of path selection or selection priority.

The fifty-fifth invention for solving the above-mentioned problems is characterized in that in the above-mentioned fifty-fourth invention, the controlling program further controls said means for selecting the communicating path so as to discard a history before a first transmitted packet validating latest path status information when a transmission cost calculation result of each path is corrected.

The fifty-sixth invention for solving the above-mentioned problems is characterized in that in one of the above-mentioned fiftieth invention to fifty-fifth invention, the controlling program further controls said means for selecting the communicating path so as to select as a packet transmission path a path having an earliest estimation value of a reception completion time at a reception node.

The fifty-seventh invention for solving the above-mentioned problems is characterized in that in one of the above-mentioned fiftieth invention to fifty-sixth invention, the controlling program further controls said means for selecting the communicating path so as to select as a packet transmission path a path having a largest estimation value of a data amount which can be completely received by a specific time at a reception node.

The fifty-eighth invention for solving the above-mentioned problems is characterized in that in one of the above-mentioned fiftieth invention to fifty-seventh invention, the controlling program further controls said means for selecting the communicating path so as to interrupt data transmission according to an estimated current path status for each path.

The fifty-ninth invention for solving the above-mentioned problems is characterized in that in the above-mentioned fifty-eighth invention a condition for interruption of said data transmission is that an estimated reception completion time is equal to or greater than a specific value.

The sixtieth invention for solving the above-mentioned problems is characterized in that in one of the above-mentioned fiftieth invention to fifty-ninth invention, the controlling program further controls said means for selecting the communicating path so as to determine path selection or transmission interruption according to a policy different every attribute of transmission data.

The sixty-first invention for solving the above-mentioned problems, which is a communication method, is characterized in affixing an identifier for identifying a transmission flow and a sequential number within said transmission flow to a transmission packet in addition to information for a sequencing to take a retransmitting control thereof per transmission flow on the receiving side, based upon said identifier and said sequential number.

The sixty-second invention for solving the above-mentioned problems, which is a communication method, is characterized in affixing an identifier for identifying a transmission flow and a sequential number within said transmission flow to a transmission packet in addition to information for a sequencing to detect a loss of the packet per transmission flow on the receiving side, based upon said identifier and said sequential number.

The sixty-third invention for solving the above-mentioned problems, which is a node, is characterized in including:

a means for affixing to the packet a first identifier, said first identifier being assigned in a one-to-one manner to each flow of a first group flow based upon a first criterion relating to a sequencing, a first sequential number, said first sequential number being unique within each flow belonging to said first group flow, a second identifier, said second identifier being assigned in a one-to-one manner to each flow of a second group flow based upon a second criterion relating to a retransmitting control, and a second sequential number, said second sequential number being unique within each flow belonging to said second group flow, to transmit it; and

a means for retransmitting the lost packets, which were detected, per transmission flow based upon said second identifier and said second sequential number.

The sixty-fourth invention for solving the above-mentioned problems, which is a controlling program of a node, is characterized in that said controlling program causes said node to function as:

a means for affixing to the packet a first identifier, said first identifier being assigned in a one-to-one manner to each flow of a first group flow based upon a first criterion relating to a sequencing, a first sequential number, said first sequential number being unique within each flow belonging to said first group flow, a second identifier, said second identifier being assigned in a one-to-one manner to each flow of a second group flow based upon a second criterion relating to a retransmitting control, and a second sequential number, said second sequential number being unique within each flow belonging to said second group flow, to transmit it; and

a means for retransmitting the lost packets, which were detected, per transmission flow based upon said second identifier and said second sequential number.

In the present invention, an identifier for a retransmitting control is affixed to the packet to be transmitted in addition to an identifier for a sequencing, a sequencing is made based upon the identifier for a sequencing, and a detection of the packet loss and a regenerating control are made based upon the identifier for a retransmitting control. The identifier for a retransmitting control is provided with an identifier per flow of retransmission, and is further given identification information such as a sequential number for allowing the packet to be specified in one-to-one manner within its flow. Normally, a relation between the flow of retransmission and the path with which reception/transmission is made is one-to-one; however it does not need to be limited hereto.

An outline of the present invention described above will be explained, by employing FIG. 15.

In FIG. 15, is shown an example of transmitting/receiving the packet between a transmitting side and a receiving side via one path a.

The first identifier for identifying a flow of the sequencing and the first sequential number, which is unique within each flow, are affixed to the packet of each flow on the transmitting side. For example, with the second packet of a flow 1, “1-2” is affixed hereto.

Further, in the present invention, the second identifier for identifying a flow of a retransmitting control and the second sequential number, which is unique within each flow, are affixed in addition to this identifier for a sequencing. Herein, a relation between the transmission flow and the path a is one-to-one, whereby the identifier for identifying the retransmission flow is assumed to be “a”, and the sequential number is affixed to the packet so that it can be specified in one-to-one manner within the flow (path a) to be identified with this “a”. Accordingly, the identifier for the retransmitting control of the first packet within the flow (path a) to be identified with “a” is “a-1”.

The transmitting side affixes the foregoing identifiers to the packets, and sequentially selects the packets one by one from each flow, and transmits them to the path a. That is, the packets are transmitted in the order of a packet (1-1,a-1), a packet (2-1,a-2), . . . , and a packet (3-3,a-9) (identifier for a sequencing, identifier for a retransmitting control). On the other hand, the transmitted packet is held as a retransmission queue.

Herein, it is assumed that a loss of the packet (2-2,a-5) occurred on the path a.

On the receiving side, the packets are received in the transmitting order, so it follows that they are received in the order of the packet (1-1,a-1), the packet (2-1,a-2), . . . , the packet (1-2,a-4), the packet (3-2,a-6), . . . , and the packet (3-3,a-9).

Herein, in the present invention, a detection of the packet loss and a retransmitting control are made based upon the identifier for a retransmitting control. In this example, confirming the identifiers for a retransmitting control of the packets received from the path a demonstrates that they are “a-4”, “a-6”, . . . , and “a-9”, whereby it is seen that “a-5” is missing at the time point that the packet (3-2,a-6) was received. Accordingly, it is seen that that the packet (2-2,a-5) having the identifier for a retransmitting control of “a-5” was lost, and a request for retransmitting this packet (2-2,a-5) is made to the transmitting side. On the transmitting side, upon receiving the request for retransmitting the packet having the identifier for a retransmitting control “a-5”, it retransmits the packet having the identifier for a retransmitting control “a-5” held in the retransmission queue.

On the other hand, the sequencing is taken based upon the identifier for the sequencing independently of the foregoing packet loss and retransmitting control, and the retransmission accompanied by the packet loss is not requested.

In such a manner, the present invention makes it possible to detect a loss of the packet (2-2,a-5) at the time point that the packet (3-2,a-6) was received to make a detection of the packet loss at an earlier stage as compared with the prior art, and further to prevent a delay of the sequencing accompanied by the packet loss because the retransmitting control as well is taken independently.

Additionally, as to a detection of the packet loss of the retransmitting control, in addition to a case where a detection of the packet loss is made on the receiving side as described above, for example, it is acceptable that the receiving side transmits information of the packet that already arrived to the transmitting side and the transmitting side detects the packet loss based upon this information.

### EFFECTS OF THE INVENTION

In the present invention, taking the sequencing and the retransmitting control independently and assigning the retransmission ID to a unit for allowing the packet loss to be detected at an earliest stage, in the packet communication, makes it possible to detect the packet loss at an earlier stage as compared with the retransmitting control that is taken flow by flow, accompanied by the conventional sequencing.

Also, according to the present invention, also in the sequencing per flow, the effect that no wasteful latency time of the packet of a certain flow due to a loss of the packet of other flow is generated, thus allowing the packet to be transferred is obtained.

Also, in the present invention, the path to be utilized for the transmission and the retransmitting control are independent of each other, so no problem occurs as a whole of the system also in a case where a certain path failed in communication.

### BRIEF DESCRIPTION OF THE DRAWINGS

FIG. 1 is a view illustrating a communication network configuration in a case where the number of the path between the transmitting node and the receiving node is one.

FIG. 2 is a view illustrating a configuration of the transmitting node or the receiving node.

FIG. 3 is a view illustrating a configuration of the packet.

FIG. 4 is a view illustrating information, which a memory section holds in a first embodiment.

FIG. 5 is a view illustrating a communication network configuration in a case where the number of the path between the transmitting node and the receiving node is M.

FIG. 6 is a view illustrating a configuration of the transmitting node or the receiving node.

FIG. 7 is a view illustrating information, which the memory section holds in a second embodiment.

FIG. 8 is a flowchart of algorithm of deciding an identical communication interface/group for a retransmission ID.

FIG. 9 is a view illustrating information, which a memory section holds in a third embodiment.

FIG. 10 is a view illustrating a communication network configuration in a case where the number of the path between the transmitting-side transferring node and the receiving-side transferring node is M.

FIG. 11 is a view illustrating a packet processing timing in the transmitting-side node and the receiving-side node in an operational example 1 of a scheduler.

FIG. 12 is an operational flowchart of a scheduling section in the operational example 1 of the scheduler.

FIG. 13 is a view illustrating a packet processing timing in the transmitting-side node and the receiving-side node in an operational example 2 of the scheduler.

FIG. 14 is an operational flowchart of a scheduling section in the operational example 2 of the scheduler.

FIG. 15 is a view for explaining the present invention.

FIG. 16 is a view for explaining a specific operation of the embodiment 1 of the present invention.

FIG. 17 is a view for explaining a specific operation of the embodiment 1 of the present invention.

FIG. 18 is a view illustrating a specific example of the packet processing timing in the transmitting-side node and the receiving-side node in the operational example 1 of the scheduler.

FIG. 19 is a view for explaining the prior art.

### DESCRIPTION OF NUMERALS

101 transmitting node
102 receiving node
110 path
201 socket
202 inputting/outputting section
211 and 222 flow identifying sections
212 and 224 per-flow queues
213 scheduler
214 retransmission controlling section
215 retransmission queue
216 memory section
221 retransmission ID sequence checking section
223 flow sequence checking section
301 transmitting node
302 receiving node
312-1 to M paths
401 socket
402-1 to M inputting/outputting sections
411 and 422 flow identifying sections
412 and 424 per-flow queues
413 scheduler
414 retransmission controlling section
415 retransmission queue
416 memory section
421 retransmission ID sequence checking section
423 flow sequence checking section
501-1 to L transmitting nodes
502 transmitting-side transferring node
503 receiving-side transferring node
504-1 to N receiving nodes
511-1 to L paths
512-1 to M paths
513-1 to N paths
600-1,2,3 data packets

### BEST MODE FOR CARRYING OUT THE INVENTION

The present invention is characterized in independently taking the sequencing and the retransmitting control in the packet communication.

For this, the transmitting node provides the first group flow having one flow or more based upon a first criterion relating to the sequencing, and the second group flow having one flow or more based upon a second criterion relating to the retransmitting control, and assigns the first identifier, which is unique, to each flow belonging to the first group flow, and the second identifier, which is unique, to each flow belonging to said second group flow. And, the transmitting node classifies the packets to be transmitted into one flow or more belonging to the first group flow based upon the first criterion, yet classifies them into one flow or more belonging to the second group flow based upon the second criterion, affixes to the transmission packet the first identifier, the first sequential number, which is unique within each flow belonging to the first group flow, the second identifier, and the second sequential number, which is unique within each flow belonging to the second group flow, and transmits it.

The receiving node classifies all received packets based upon the second identifier, checks the packets having the second sequential number, which were not received, with each second group flow, and requests retransmission of the packet responding to the second sequential number, which were not received. And the transmitting node retransmits the packet responding to the second sequential number of the second group flow, which is requested by the receiving node, and thereby takes a control of the retransmission.

Also, the receiving node classifies all received packets based upon the first identifier, and sequences the packets based upon the first sequential number with each first group flow, and performs a receiving process of the sequenced packets in the sequenced order, thereby the sequencing of the packets is taken.

Hereinafter, specific embodiments will be explained.

### Embodiment 1

The embodiment 1 of the present invention will be explained.

In the embodiment 1, a case where the transmitting node and the receiving node are connected via one path will be explained.

Upon making a reference to FIG. 1, the embodiment 1 of the present invention is comprised of a transmitting node 101, a receiving node 102, and a path 110 for making a connection between the nodes. The path 110 is a packet communication network such as an internet. Additionally, both of the communication, which is made to the receiving node 102 from the transmitting node 101, and the communication, which is made to the transmitting node 101 from the receiving node 102, can be considered. For a convenience of explanation, the nodes are named as a transmitting/receiving node respectively; however their functions are identical.

Next, a configuration of the transmitting node 101 will be explained.

FIG. 2 is a view illustrating the configuration of the transmitting node 101.

Upon making a reference to FIG. 2, the transmission node 101 is comprised of a socket 201, being an API (Application Process Interface) with an application, an inputting/receiving section 202, a flow identifying section 211 for identifying flows from a port number to be used and an address/port number of a destination to distribute them to respective queues, a flow identifying section 222 for identifying flows from a flow ID to distribute them to respective queues, per-flow queues 212 and 224 for holding the packets per identified flow, a scheduler 213 for selecting the packet to be transmitted from among the packets of the per-flow queue 212 to transmit it, a retransmission controlling section 214 for affixing retransmission IDs to the packets at the time of transmitting them and for causing a retransmission queue 215 to hold them per retransmission ID for preparing for retransmission, the retransmission queue 215 for holding the packets per retransmission ID, a memory section 216 having information such as a delay per path or a delay dispersion and sequential number information per flow or per retransmission ID recorded, a retransmission ID sequence checking section 221 for checking the retransmission ID of the packet at the time of receiving it to check whether the packets arrived in due sequence, and a flow sequence checking section 223 for checking the per-flow queue 224 in order to transfer the sequenced packets out of the packets of the per-flow queue 224.

Additionally, the configuration of the receiving node 102 is identical to that of the transmitting node 101.

Hereinafter, an operational example in a case of transmitting the packet from the transmitting node 101 to the receiving node 102 will be explained.

The transmitting node generates communication employing an arbitrary number of TCPs and UDPs with an arbitrary number of applications. Herein, the so-called first criterion is a criterion relating to the sequencing of the packet, and each communication of the TCPs and the UDPs is equivalent to the first group flow.

When the socket 201 receives the packet from the application, which is delivered to the flow identifying section 211, the flow identifying section 211 identifies its flow from the port number of its own node and the address/port number of a destination of the packet. The identified packet is filed flow by flow in the per-flow queue 212.

In FIG. 2, an example is shown of the per-flow queue having the seventy flows; however it is not limited to this number and it doesn't matter whether it is numerous or few. After a process necessary for retransmission at the moment of the packet loss was performed for the packets filed in the per-flow queue 212 by the scheduler 213 and the retransmission controlling section 214, they are transmitted to the receiving node 102 via the inputting/outputting section 202, and are held also in the retransmission queue 215 for coping with the packet loss.

Next, operations of the scheduler 213 and the retransmission controlling section 214 will be explained.

The scheduler 213 sets a transmission timing of the packet to be transmitted, decides the queue, which transmits the packet to the receiving node 102, from the per-flow queue 212 at a transmitting timing, and fetches the packet from the corresponding queue. The fetched packet is delivered to the retransmission controlling section 214 in order to perform a process necessary for retransmission.

The retransmission controlling section 214 takes a retransmitting control with a second criterion different from the first criterion which is a criterion relating to the foregoing packet transmission. Herein, the so-called second criterion is a criterion relating to the retransmission of the packet. Specifically, the retransmission controlling section 214 decides the retransmission ID and the retransmission sequential number to be affixed to the transmission packet, by making a reference to the memory section 216, and files the packet in a predetermined queue of the retransmission queue 215. The second group flow is equivalent to a packet group with this retransmission ID assumed to be a unit. Additionally, herein, the second group flow corresponds to the path one to one.

The retransmission controlling section 214 notifies the decided retransmission ID and retransmission sequential number to the scheduler 213, and the scheduler 213 affixes the notified retransmission ID and retransmission sequential number (second identifier for a retransmitting control, and second sequential number), the flow ID acquired from the memory section 216, which is assigned in a one-to-one manner per flow, and the flow sequential number (first identifier for a sequencing and first sequential number), which is unique in the flow, as an original header, and transmits the packet to the receiving node 102 by utilizing the inputting/outputting section 202.

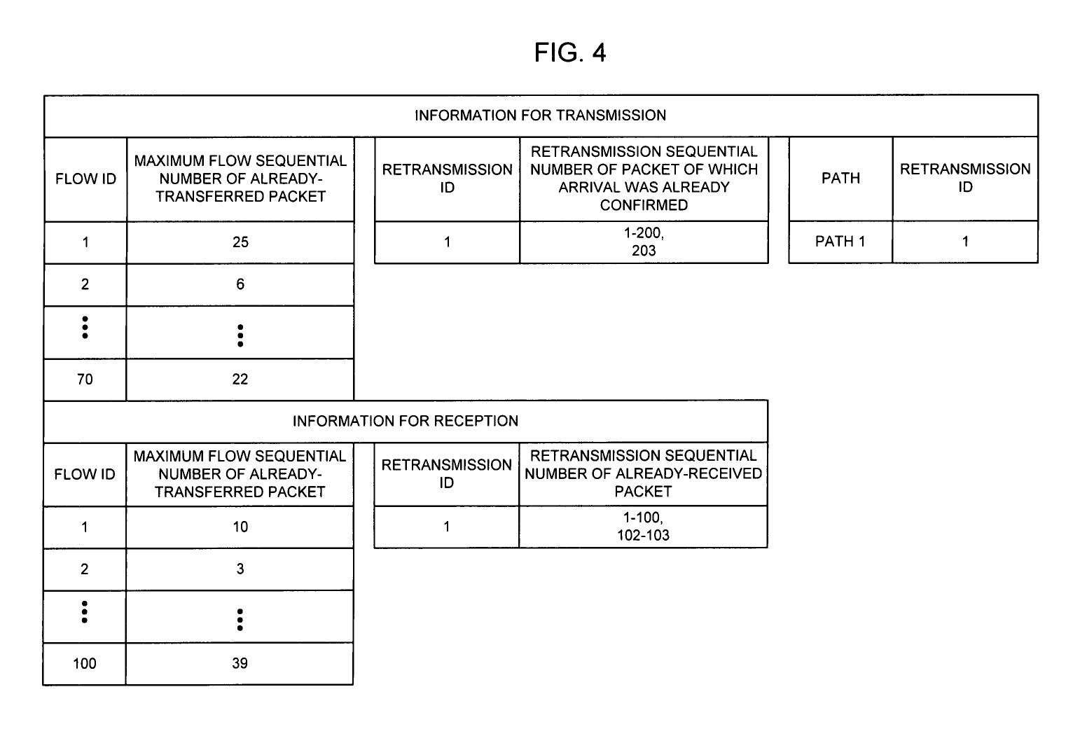

So as to perform the operation above, the memory section 216 holds information, for example, as shown in FIG. 4. In FIG. 4, the situation is depicted in which the flow ID (first identifier for a sequencing) and a maximum flow sequential number (first sequential number) of the already-transferred packet, the retransmission ID (second identifier) for a retransmitting control, and a retransmission sequential number (second sequential number) of the packet that already arrived were stored as information for transmission. For example, with a flow ID “1”, the maximum flow sequence of the packet that already transferred is “25”. Also, it is depicted that with a retransmission ID “1”, the retransmission sequential numbers of the packets that already arrived are “1 to 200 and 203”. Additionally, out of the retransmission sequential numbers of the packet that already arrived, the numbers “201 and 202”, which were not described, are the sequential number of the packets which have not been confirmed.

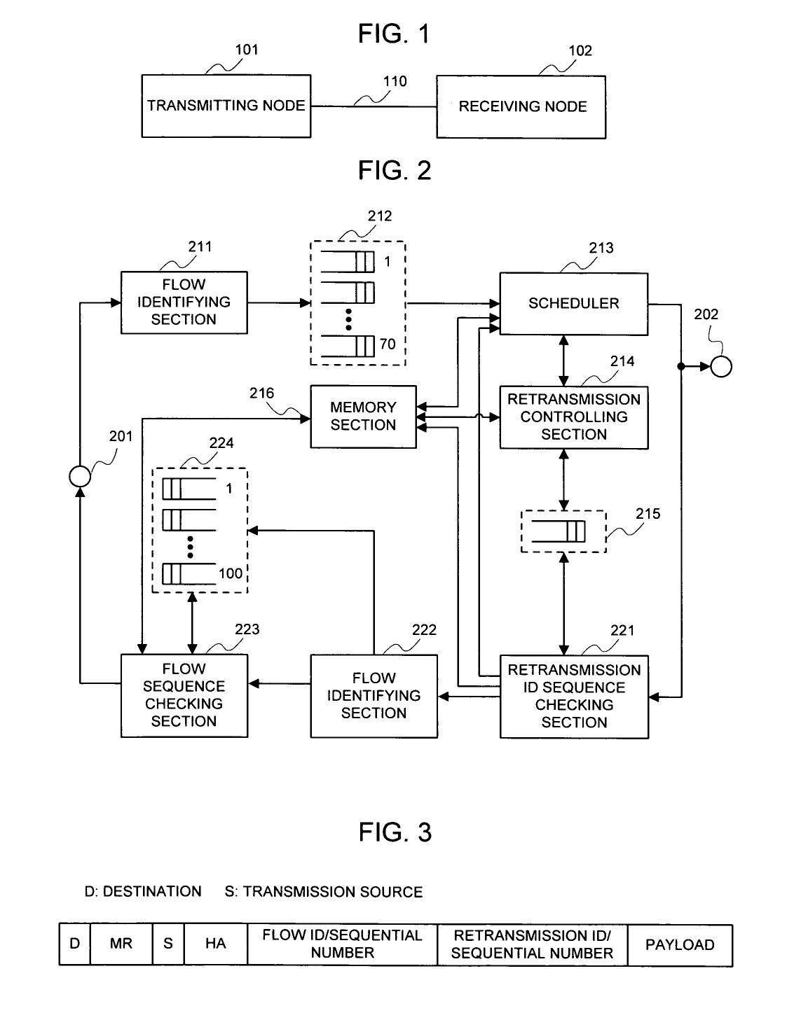

The foregoing is the operation of the scheduler 213 and the retransmission controlling section 214. The format of the transmission packet at this time is one, for example, shown in FIG. 3.

Continuously, the receiving node 102 will be explained. In explanation below, a case will be explained where the receiving node 102 receives the packet transmitted from the inputting/outputting section 202 of the transmitting node 101 via the inputting/outputting section 202. Additionally, the present invention is applicable either in a case where it is a node on the data receiving side that determines that the packet loss occurred, or in a case where it is a node on the data transmitting side that does so; however a case is herein shown where the data receiving side transmits only an ACK for conveying an arrival confirmation and the transmitting side determines that the packet loss occurred with an arbitrary criterion. Also, in the present invention, the transmitting node 101 and the receiving node 102 have an identical configuration, so an operational example of the receiving node 102 will be explained, by employing FIG. 2.

The packet received from the inputting/outputting section 202 is input into the retransmission ID sequence checking section 221.

When the retransmission ID sequence checking section 221 confirms that it is a data packet, it acquires the retransmission ID and the retransmission sequential number from the packet, and delivers ACK information, which is comprised of the retransmission ID of the received packet and the retransmission sequential number of the received packet, to the scheduler 213.

The scheduler 213 to which the ACK information was delivered transmits an ACK packet including the delivered ACK information via the inputting/outputting section 202 in order to notify the transmitting node 101 that the packet was received. In a case where the other transmission data packet exists at a timing of transmitting the ACK packet, the scheduler 213 also can affix information to a header portion of the data packet without generating an independent ACK packet.

Also, the retransmission ID sequence checking section 221 notifies the memory section 216 of retransmission sequential number information of the retransmission ID of the received packet, updates the retransmission sequential number information stored in the memory section 216, and thereby, the retransmission controlling process is completed. After completion of the retransmission controlling process, the retransmission ID sequence checking section 221 supplies the received packet to the flow identifying section 222, and thereby the sequencing process is performed.

In the sequencing process, the flow identifying section 222 acquires the flow ID from the packet supplied from the retransmission ID sequence checking section 221, and transmits the packet to the corresponding queue of the per-flow queue 224 according to the flow ID. In FIG. 2, an example of the configuration of the per-flow queue having 100 different flows is shown.

Also, simultaneously, the flow identifying section 222 notifies the flow sequence checking section 223 that the packet was newly received, together with the flow ID. The flow sequence checking section 223 acquires the already-transmitted maximum flow sequential number with the corresponding flow ID from the memory section 216.

Next, the flow sequence checking section 223 checks the queue responding to the flow ID that was input. As a result of checking, if the maximum flow sequential number of the continuous packets exists in the maximum flow sequential numbers of the already-transferred packets, the flow sequence checking section 223 fetches this continuous packets, deletes the flow ID, the flow sequential number, the retransmission ID, and the retransmission sequential number within a frame format shown in FIG. 3, and delivers them to the application via the socket section 201. On the other hand, unless the maximum flow sequential number of the continuous packets exists in the maximum flow sequential numbers of the already-transferred packets, the flow sequence checking section 223 finishes the operation.

The subsequent operation is similar to that of the foregoing transmitting node.

Continuously, the transmitting node having received the ACK information from the receiving node will be explained.

When the transmitting node 101 receives the packet including ACK information coming from the receiving node 102 from the inputting/outputting section 202, it fetches the ACK information in the retransmission ID sequence checking section 221. Next, it acquires the retransmission ID and the retransmission sequential number, which the receiving node 102 received, from the ACK information, stores this retransmission ID and retransmission sequential number as the packet of which arrival was already confirmed in the memory section 216, and deletes the packet, which corresponds to its retransmission ID and retransmission sequential number, from the per-retransmission-ID queue 215.

Also, the transmitting node 101 checks the stored retransmission ID and retransmission sequential number regularly, which already arrived, and detects the missing retransmission sequential number. And, it regards the packet responding to the missing retransmission ID and retransmission sequential number as a lost packet, fetches the packet, which corresponds to the missing retransmission ID and retransmission sequential number, from the retransmission ID queue 215, delivers the packet to the scheduler 213, and notifies it that the retransmission is required. The scheduler 213 makes retransmission of the delivered packet. Additionally, at this moment, it affixes to the retransmission packet the retransmission ID and retransmission sequential number identical to the retransmission ID and retransmission sequential number affixed to the previously-transmitted packet to retransmit it.

Next, a specific example of the foregoing operation will be explained, by making a reference to the accompanied drawings.

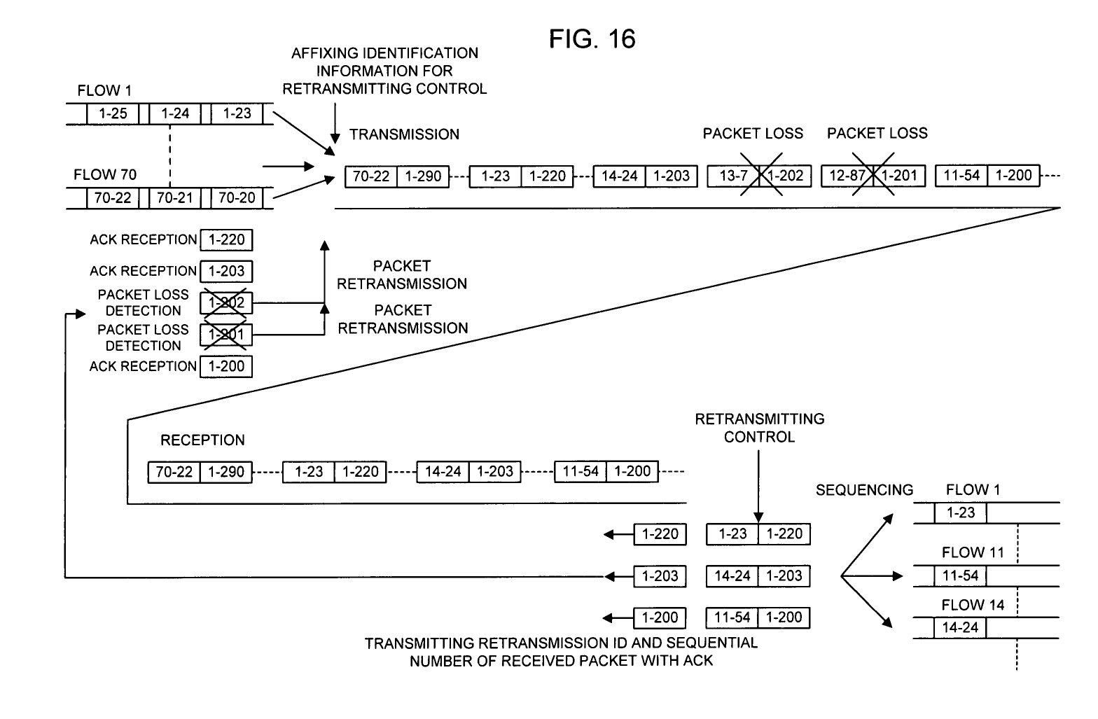

FIG. 16 is a view for explaining a specific operation between the transmitting node 101 and the receiving node 102. Additionally, in explanation below, in order to show the specific operational example, a configuration shown in FIG. 2 and information for retransmission shown in FIG. 4 are exemplified for explanation.

At first, the scheduler 213 of the transmitting node 101 fetches the packets one by one from seventy flows of the per-flow queue 212, and the retransmission controlling section 214 affixes the retransmission ID and the retransmission sequential number to the transmission packet, by making a reference to the memory section 216. For example, if the retransmission ID is “1” and the retransmission sequential number is “200”, the transmission packet has the number like “1-200” affixed. And, the packet to which was affixed this retransmission ID and retransmission sequential number is transmitted toward the receiving node 102 via the inputting/outputting section 202, and is also held in the retransmission queue 215 for coping with the packet loss.

In an example of FIG. 16, it is the flow ID and the flow sequential number that were affixed to the front half of one packet, and it is the retransmission ID and the retransmission sequential number that were affixed to the latter half thereof. In FIG. 16, the packets are transmitted on the path in such an order of a packet (11-54,1-200), a packet (12-87,1-201), a packet (13-7,1-202), a packet (14-24,1-203), . . . . Additionally, with a packet (m-n,x-y), m represents the flow ID, n represents the flow sequential number, x represents the retransmission ID, and y represents the retransmission sequential number.

Now think about a case where the packet (12-87,1-201) and the packet (13-7,1-202) were lost in such a situation.

On the receiving-node side, the packet (11-54,1-200), the packet (14-24,1-203), . . . are received from the inputting/outputting section 202, and are input into the retransmission ID sequence checking section 221. When the retransmission ID sequence checking section 221 confirms that it is a data packet, it acquires the retransmission ID and the retransmission sequential number in such a manner of “1-200” and “1-203” respectively, and delivers the ACK information, which is comprised of this retransmission ID and retransmission sequential number of the received packet, to the scheduler 213.

In order to notify the transmission node 101 that the packet was received, the scheduler 213 to which the ACK information was delivered transmits an ACK packet including the delivered ACK information hereto via the inputting/outputting section 202.

Also, the retransmission ID sequence checking section 221 notifies the memory section 216 of the retransmission sequential number of the retransmission ID of the received packet, and updates the retransmission sequential number of the already-received packet stored in the memory section 216, and thereby, the retransmission controlling process is completed. After completion of the retransmission controlling process, the retransmission ID sequence checking section 221 supplied the received packet to the flow identifying section 222, and thereby the sequencing process is performed.

In the sequencing process, the flow identifying section 222 acquires a flow ID “11”, . . . , a flow ID “14”, . . . , a flow ID “1” from the packets supplied from the retransmission ID sequence checking section 221, and transmits the packets to the corresponding queues of the per-flow queue 224 according to the flow ID. In FIG. 16, the situation is shown in which the received packet (14-24) was transmitted to a flow 14, the packet (11-54) to a flow 11, and the packet (1-23) to a flow 1.

On the other hand, when the transmitting node 101 receives the packet including the ACK information coming from the receiving node 102 from the inputting/outputting section 202, it fetches the ACK information in the retransmission ID sequence checking section 221.

Next, the transmitting node 101 acquires the retransmission ID and the retransmission sequential number, which the receiving node 102 received, from the ACK information, stores this retransmission ID and retransmission sequential number as the packet of which arrival was already confirmed in the memory section 216, and deletes the packet, which corresponds to its retransmission ID and retransmission sequential number, from the per-retransmission-ID queue 215.

For example, in a case where the transmitting node 101 acquired the ACK information named “1-200” and “1-203”, it adds “200” and “203” to the retransmission sequential number of the packet, which already arrived, in the retransmission ID “1” of information for transmission, and deletes the packets of which the retransmission sequential number are “200” and “203” from the per-retransmission-ID queue 215.

Also, the retransmission controlling section 214 checks the retransmission ID and the retransmission sequential number, which already arrived, for every constant interval, and detects the missing retransmission sequential number. In an example of FIG. 16, the retransmission sequential numbers “201” and “202” are missing. Thereupon, the retransmission controlling section 214 regards the packets, which correspond to the missing retransmission sequential numbers “201” and “202” as a lost packet respectively, fetches the packets responding to the retransmission sequential numbers “201” and “202” from the retransmission ID queue 215, delivers the packets to the scheduler 213, and notifies it that the retransmission is required. The scheduler 213 makes retransmission of the delivered packets. Additionally, at this time, it affixes the retransmission ID and retransmission sequential number affixed to the previously transmitted packet, i.e. “1-201” and “1-202” to the transmission packet, and retransmits them.

The operation above allows the packet loss to be found out at an early stage, thus making it possible to make data transmission/reception between the receiving node 102 and the transmitting node 101 in a shorter time.

Next, an example will be described of a case of detecting the packet loss in the receiving-side node 102.

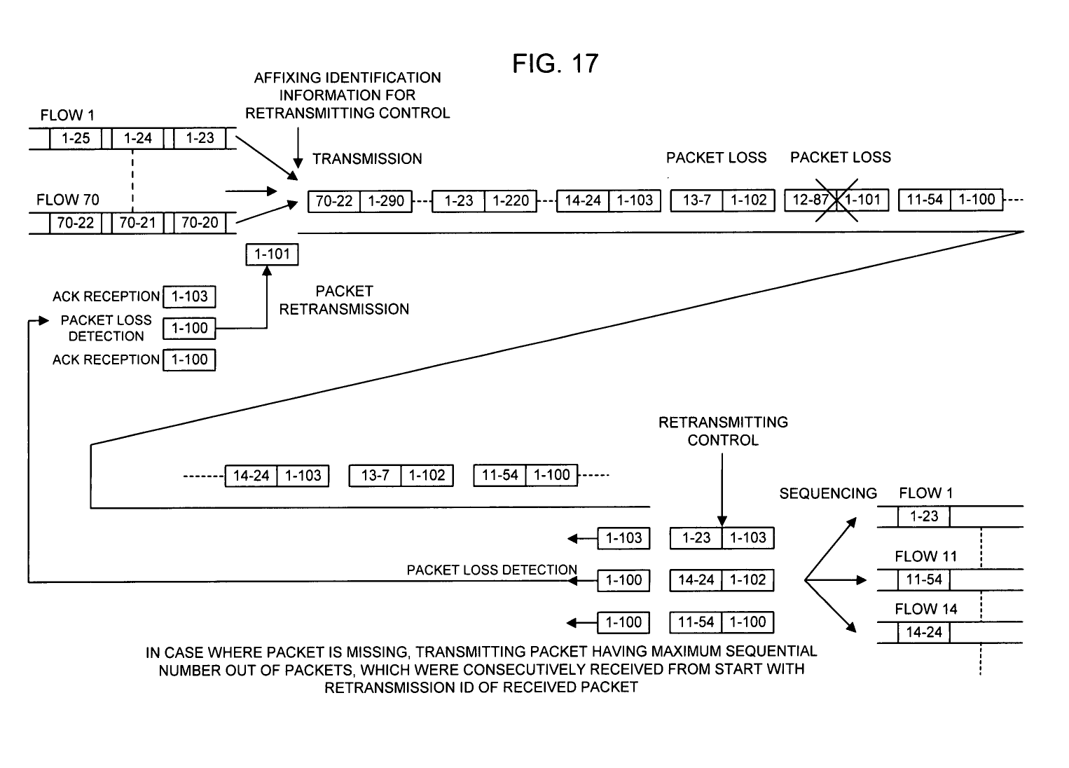

FIG. 17 is a view for explaining a case of detecting the packet loss in the receiving-side node 102. Additionally, the information for reception shown in FIG. 4 is employed as information to be employed for detecting the packet loss in the receiving-side node 102. Also, the operation, which is performed during the time that the packet reaches the receiving-side node from the transmitting-side node, is similar to the foregoing operation, so specific explanation is omitted.

In FIG. 17, the packets are transmitted on the path in such an order of a packet (11-54,1-100), a packet (12-87,1-101), a packet (13-7,1-102), a packet (14-24,1-103), . . . . Herein, think of a case where the packet (12-87,1-101) was lost.

On the receiving node side, the packet (11-54,1-100), the packet (13-7,1-102), the packet (14-24,1-103), . . . are received from the inputting/outputting section 202, and are input into the retransmission ID sequence checking section 221. When the retransmission ID sequence checking section 221 confirms that each of them is a data packet, it acquires the retransmission ID and retransmission sequential number in such a manner of “1-100”, “1-102” from the packets, and determines whether the packet, which was expected to be received, was received, by comparing this retransmission ID and retransmission sequential number with the retransmission ID and the retransmission sequential number of the already-received packet stored in information for reception of the memory section 216.

As a result of the determination, in a case where it was the packet, which was expected, the retransmission ID sequence checking section 221 delivers the ACK information, which is comprised of the retransmission ID of the received packet and the retransmission sequential number of the received packet, to the scheduler 213. On the other hand, in a case where it was not the packet, which was expected, the retransmission ID sequence checking section 221 delivers to the scheduler 213 the ACK information, which is comprised of the retransmission ID of the received packet and the maximum retransmission sequential number out of the retransmission sequential numbers of the packets which were continuously received from the start with the retransmission ID of the received packet.

Herein, the received packet (11-54,1-100) is a packet that is expected, whereby, it delivers to the scheduler 213 the ACK information, which is comprised of the retransmission ID of the received packet and the retransmission sequential number of the received packet, i.e. “1-100”. And, it notifies the memory section 216 of “1-100”, being information of the retransmission ID and the retransmission sequential number of the received packet, and updates the retransmission sequential number information stored in the memory section 216, and thereby the retransmission controlling process is completed.

Continuously, the received packet (13-7,1-102) is originally ought to be the packet (12-87,1-101) of which the retransmission sequential number is 101. Thereupon, it delivers to the scheduler 213 the maximum retransmission sequential number out of the retransmission sequential numbers of the packets, which were continuously received from the start with the retransmission ID of the received packet, i.e. “1-100”. And, it notifies the memory section 216 of “1-102”, being information of the retransmission ID and retransmission sequential number of the received packet, and updates the retransmission sequential number information stored in the memory section 216, and thereby the retransmission controlling process is completed.

Next, the received packet (1-23,1-103) is a packet that is expected, whereby it delivers to the scheduler 213 the ACK information, which is comprised of the retransmission ID of the received packet and the retransmission sequential number of the received packet, i.e. “1-103”. And, it notifies the memory section 216 of “1-103”, being information of the retransmission ID and the retransmission sequential number of the received packet, and updates the retransmission sequential number information stored in the memory section 216, and thereby the retransmission controlling process is completed.

In order to notify the transmission node 101 that the packet was received, the scheduler 213 to which the ACK information was delivered transmits an ACK packet including the delivered ACK information hereto via the inputting/outputting section 202.

The sequencing process after completion of the retransmitting controlling process is an operation identical to the foregoing, so explanation is omitted.

Continuously, the transmitting node having received ACK information from the receiving node will be explained.

When the transmitting node 101 receives the packet including the ACK information coming from the receiving node 102 from the inputting/outputting section 202, it fetches the ACK information in the retransmission ID sequence checking section 221. Next, it acquires the retransmission ID and the retransmission sequential number, which the receiving node 102 received, from the ACK information, stores this retransmission ID and retransmission sequential number as the packet of which arrival was already confirmed in the memory section 216, and deletes the packet responding to its retransmission ID and retransmission sequential number from the per-retransmission-ID queue 215.

Herein, firstly, the transmitting node 101 receives “1-100”, “1-101”, and “1-103” as information of the ACK information. At first, with “1-100”, the transmitting node 101 stores it as the packet of which arrival was already confirmed in the memory section 216, and deletes the packet responding to its retransmission ID and retransmission sequential number from the per-retransmission-ID queue 215. Continuously, in a case where the transmitting node 101 received “1-100” having an identical content, it regards the packet responding to “1-101”, being the number next to its retransmission sequential number, as a lost packet, and makes retransmission thereof. That is, in a case where the transmitting sequential numbers having an identical number arrived two consecutive times, it regards the packet responding to the number next to its retransmission sequential number as a lost packet, and makes retransmission thereof. Additionally, it affixes to the retransmission packet the retransmission ID and retransmission sequential number identical to the retransmission ID and retransmission sequential number affixed to the previously transmitted packet to retransmit it.

Above, an example was explained of a detection of the packet loss on the transmitting side and a detection of the packet loss on the receiving side; however the present invention is not limited hereto. For example, as another example is also considered the method in which, unless the receiving node received the packets of which retransmission sequential numbers were consecutive, it transmits only its missing retransmission sequential number as retransmission request information to the transmitting node and the transmitting node transmits the packet responding to this missing retransmission sequential number.

### Embodiment 2

The embodiment 2 of the present invention will be explained.

In the embodiment 2, a case will be explained where there exist a plurality of the paths for connecting the transmitting node and the receiving node.

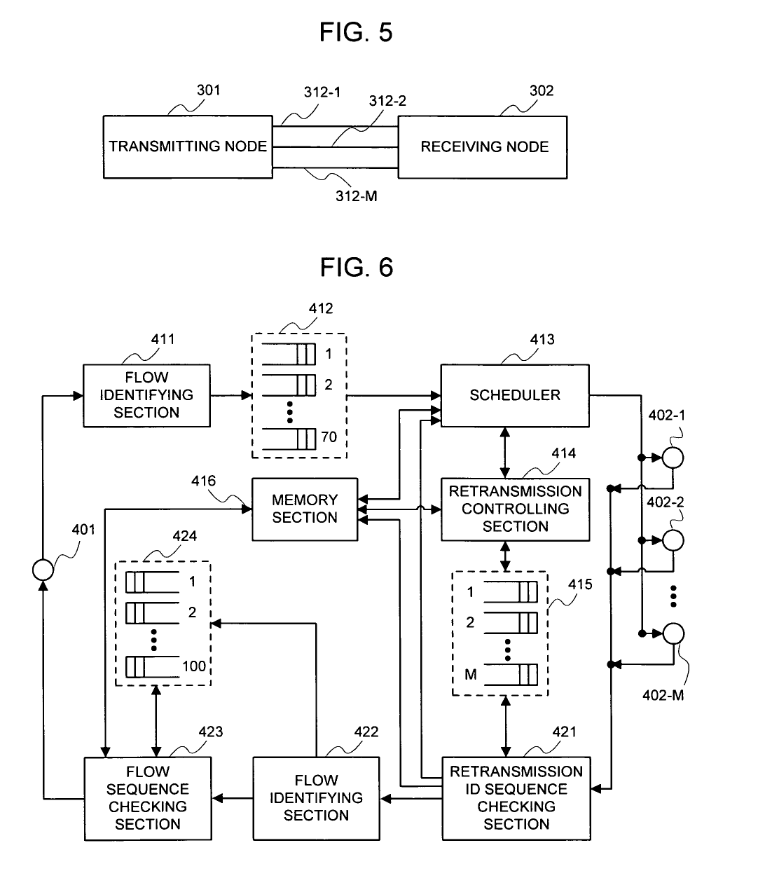

FIG. 5 is a configuration view in a case where there exist a plurality of the paths for connecting the transmitting node and the receiving node.

Upon making a reference to FIG. 5, the embodiment 2 is comprised of a transmitting node 301, a receiving node 302, and M paths 312-1 to 312-M for making a connection between the nodes. Each of the paths 312-1 to 312-M is a packet communication network such as an internet. The so-called case where a plurality of the paths, i.e. M paths exist is a case where both of the transmitting node 301 and the receiving node 302 or one of them hold a plurality of communication interfaces. For example, it is a case where either the transmitting node 301 or the receiving node 302 has M communication interfaces, or a case where the transmitting node 301 and the receiving node 302 have S communication interfaces and t communication interfaces respectively and M=s x t.

Assuming that communication is made to the receiving node 302 from the transmitting node 301, but an acknowledge (ACK) message is transmitted to the transmitting node 301 from the receiving node 302. In such a manner, in this embodiment, communication from the transmitting node 301 to the receiving node 302 will be explained; however in general, so as to make bi-directional communication, the transmitting node 301 and the receiving node 302 are required to have an identical function.

Next, a configuration of the transmitting node 301 will be explained.

Upon making a reference to FIG. 6, the transmission node 301 is comprised of a socket 401, being an API with an application, inputting/receiving sections 402-1 to 402-M, a flow identifying section 411 for identifying flows from a port number to be used and an address/port number of a destination to distribute them to respective queues, a flow identifying section 422 for identifying flows from flow IDs to distribute them to respective queues, per-flow queues 412 and 424 for holding the packets per identified flow, a scheduler 413 for selecting the transmission packet from among the packets of the per-flow queues to transmit it, a retransmission controlling section 414 for affixing retransmission IDs to the packets at the time of transmitting them to hold the them per retransmission ID in a retransmission queue for preparing for retransmission thereof, a retransmission queue 415 for holding the packets per retransmission ID, a memory section 416 having information such as a delay per path and a delay dispersion and sequential number information per flow or per retransmission ID recorded, a retransmission ID sequence checking section 421 for checking the retransmission ID of the packets at the time of receiving them, thereby to check whether the packets arrived in due sequence, and a flow sequence checking section 423 for checking the per-flow queue in order to transfer the sequenced packets, out of the packets of the per-flow queue.

Additionally, each of the inputting/receiving sections 402-1 to 402-M is a logical section responding to each of the paths 312-1 to 312-M, and the number of the physical communication interface, which the transmitting node 301 has, is not always M. Also, the receiving node 302 is identical to the transmitting node 301.

Next, an operation of the embodiment 2 in the above-mentioned configuration will be explained.

The operation of the embodiment 2, which is substantially identical to that of the embodiment 1, differs in processes of the scheduler and the retransmission controlling section because there exist a plurality of the paths. The operation of its different parts will be explained below.

The scheduler 413 sets a transmission timing of the packet to be transmitted, decides the queue for transmitting the packet to the receiving node 302 from the per-flow queue 412 at a transmitting timing, and fetches the packet from the corresponding queue. Also, the scheduler 413 decides which path should be utilized out of the paths 312-1 to 312-M based upon the third criterion relating to the path selection.

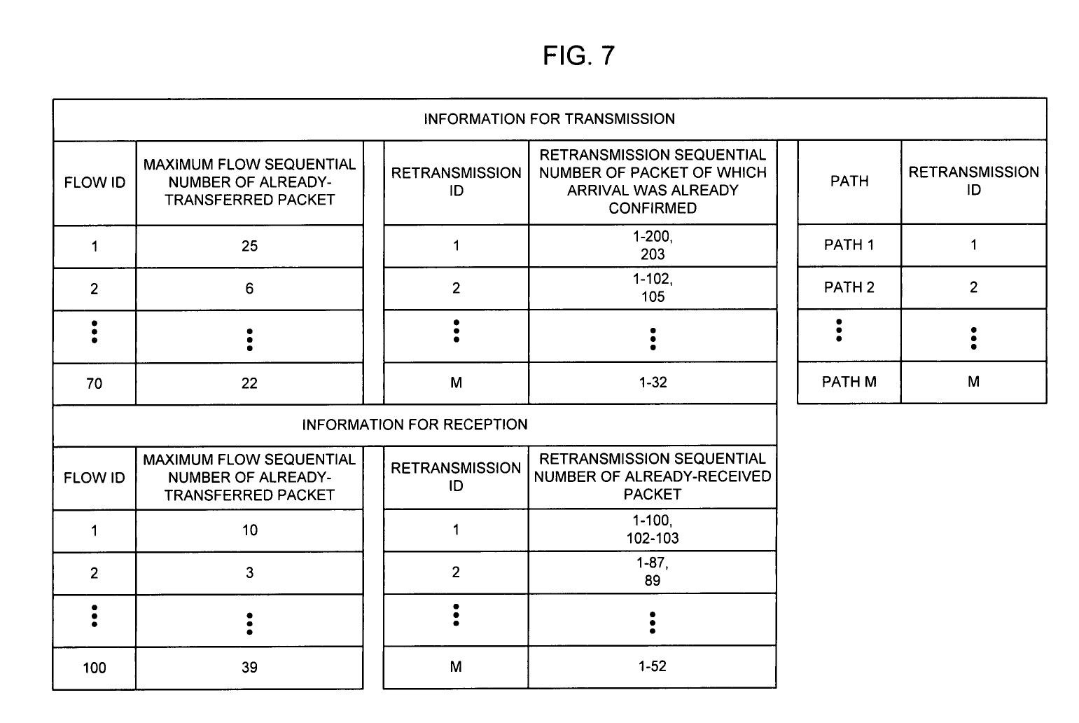

In order to perform a process necessary for retransmission, the scheduler 413 delivers the fetched packet to the retransmission controlling section 414 together with information of the path to be utilized. The retransmission controlling section 414 decides the retransmission ID and the retransmission sequential number to be affixed to the transmission packet, by making a reference to the memory section 416, and files the packet into a predetermined queue of the retransmission queue 415. Information of the memory section 416 for deciding the retransmission ID for the transmission packet is, for example, one shown in a table part of the path and the retransmission ID of FIG. 7. The number of the retransmission ID is equal to M, being the number of the inputting/outputting section, and the former corresponds to the latter in a one-to-one manner. The second group flow represents a packet group with this retransmission ID assumed to be a unit. The retransmission controlling section 414 notifies the scheduler 413 of the decided retransmission ID and retransmission sequential number, and the scheduler 413 affixes the notified retransmission ID and retransmission sequential number, the flow ID acquired from the memory section 416, which is assigned in a one-to-one manner flow by flow, and the flow sequential number, which is unique in the flow, as an original header, and transmits the packet to the receiving node 302 according to the foregoing selection by utilizing anyone of the inputting/outputting sections 402-1 to 402-M 202. The format of the transmission packet at this time is, for example, one as shown in FIG. 3.

An operation of the receiving node 302 at the time of receiving the packet differs only in an operation at the moment of transmitting the ACK. Its operation will be explained below.

The scheduler 413 transmits the ACK information including the retransmission ID and the retransmission sequential number to the transmitting node 301. In a case where the transmission data packet exists at a timing of transmitting the ACK packet, it also can affix information to the header part of the data packet without generating an independent ACK packet. According to the third criterion for selecting the communicating path, it utilizes anyone of the inputting/outputting sections 402-1 to 402-M at an appropriate timing, thereby to transmit the packet to the transmitting node 301. As a third criterion, there exists, for example, the criterion of selecting the path of which a load is least based upon a load situation of each path.

An operation of the transmitting node 301 at the moment of having received the ACK also differs in an operation of the scheduler 413. It will be explained below.

The scheduler 413 makes retransmission of the delivered packet from anyone of the inputting/outputting sections 402-1 to 402-M at an arbitrary timing. At this time, the scheduler 413 can select the transmission path independently of the path, with which the identical packet was previously transmitted, based upon the third criterion.

The operation above allows the packet loss to be found out at an early stage, thus making it possible to make data transmission/reception between the receiving node 302 and the transmitting node 301 in a shorter time.

Additionally, in the configurations of FIG. 5 and FIG. 6, a plurality of the packets belonging to one flow are generally distributed to the different paths by the scheduler 413 of the transmitting node. In a case where a delay or a rate of each path fluctuates independently, there is a limit to an offset of a delay difference between the paths by the scheduler, and in a case of including a wireless link having a low stability, a jitter between the paths is difficult to offset completely.

Accordingly, when an attention is paid to the flow, it is not guaranteed that an arrival sequence of the packet in the receiving node reflects a transmission sequence in the transmitting node. For example, it is assumed that a packet A belonging to a certain flow is transmitted from the path 312-1 and thereafter a packet B having a sequential number larger than that of the packet A, which belongs to an identical flow, is transmitted from the path 312-2. Also, it is assumed that a delay of the path A at this time was larger than a delay expected by the scheduler and B was received ahead of A in the receiving node.

At this time, if the receiving node makes a detection of a loss based upon the sequential numbers per flow of the sequencing, it detects a loss of the packet A because the packet A having a younger sequential number was not received at the time of receiving the packet B. As it is, actually, the packet A is not lost because it is received through the path 312-1 having a large delay after receiving B, so the loss detection of the packet A is an error detection.

In this embodiment of taking the retransmission control not per flow of the sequencing but per path, as far as a sequential reversal of each path does not occur, a discontinuity in the receiving node of the sequential number to be employed for retransmission reflects a packet loss without fail, whereby the error detection as explained above is avoided. Also, if a probability that the sequential reversal of each path occurs is lower as compared with the sequential reversal within the flow due to a jitter between the paths, a decline in the error detection in accordance with the present invention can be expected.

### Embodiment 3

The embodiment 3 of the present invention will be explained.

The embodiment 3 is fully identical to the embodiment 2 in terms of an arrangement of the nodes and a functional configuration of the node; however only a process is different of deciding the retransmission ID for the transmission packet in the transmitting node, so it will be explained below.

In the embodiment 3, the path and the retransmission ID, which do not correspond one to one, can be altered freely. Normally, in a case where a plurality of the paths are collected into a mass having one retransmission ID, there is a possibility that the arrival sequence of the packet at the moment that the receiving node receives the packet is remarkably disordered, depending upon delays of respective paths belonging to its retransmission ID, or a delay dispersion. For this, algorithm will be explained for deciding a plurality of the paths belonging to one retransmission ID such that a provability that the arrival sequence of the packets belonging to one retransmission ID is not correct becomes a fixed value or less.

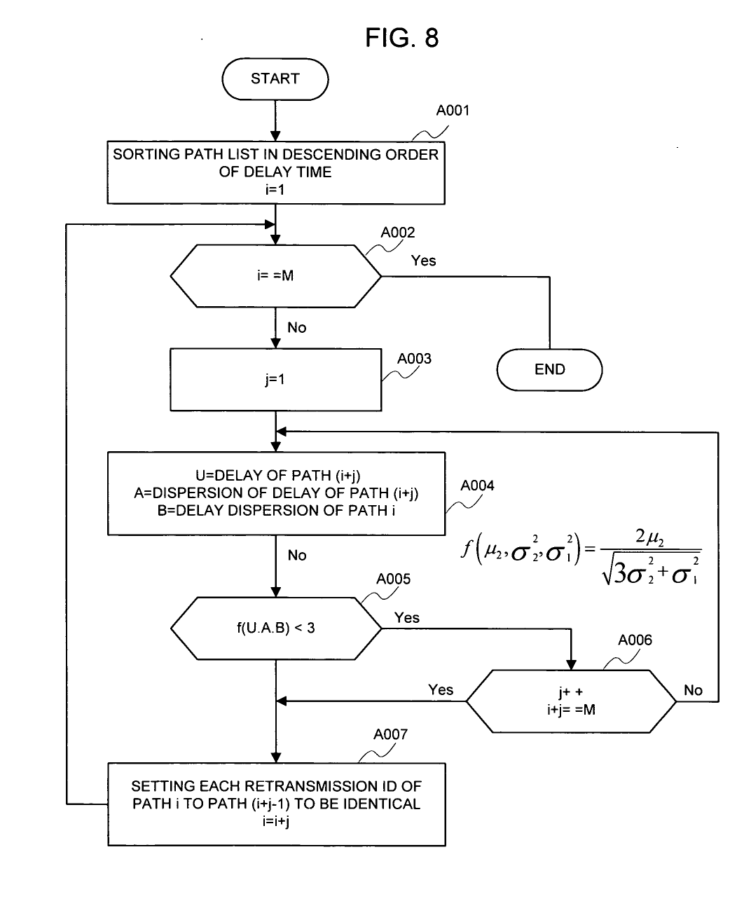

With each of the paths 312-1 to 312-M between the transmitting node 301 and the receiving node 302, a one-way or a round-trip delay time and delay dispersion are measured at any time to make a mapping of the path and the retransmission ID at an arbitrary timing. The timing is, for example, a timing of a fixed time interval, the timing at which path information is updated, or the like. The method of the mapping is a method of making a mapping of the retransmission ID upon the paths 312-1 to 312-M, for example, by means of the algorithm as shown in FIG. 8.

Upon making a reference to FIG. 8, the paths 312-1 to 312-M are re-sequenced in the order of the descending value of the delay time at the current time, and also are set to a primary variable i=1 (step A001). Next, it is checked whether i==M (step A002). In the first place, i==M is not obtained, so the operation proceeds to a step A003 and a temporary variable j=1 is set. Next, a delay and a delay dispersion of a path (i+j) and a delay dispersion of a path i are acquired (step A004).

In a case where the transmitting side used its discretion for the arrival time to transmit the packets so that the packets was able to be received in due sequence on the receiving side, it is checked whether a provability that an arbitrary number of the packets of the path (i+j), which arrives ahead until the packet of the path i which should arrive in the first place arrives is suppressed at a certain fixed level (step A005). An example of FIG. 8 is based upon the condition that a probability that three packets of the path (i+j) arrive ahead of the packet of the path i is 1.5% or less. If the condition is met, j is incremented, it is checked whether i+j==M, and it is checked whether the process was completed with all paths (step A006). Unless the process was completed with all paths, the operation returns to (step A004), and next the paths having a large delay are also checked similarly.

In the step A006, in a case of i+j==M, the operation proceeds to (step A007). If the path, which does not meet the condition of (step A005), appears while (step A004) and (step A005) are repeated, the operation proceeds to (step A007). In (step A007), the retransmission IDs of the paths ranging from the path i to path (i+j−1) are set to an identical one, and the operation returns to (A002).

When the foregoing process is repeated to finish a setting of the retransmission ID for all paths, that is, i==M is yielded in the step A002, the operation finishes, and it sleeps until the next mapping process starts.

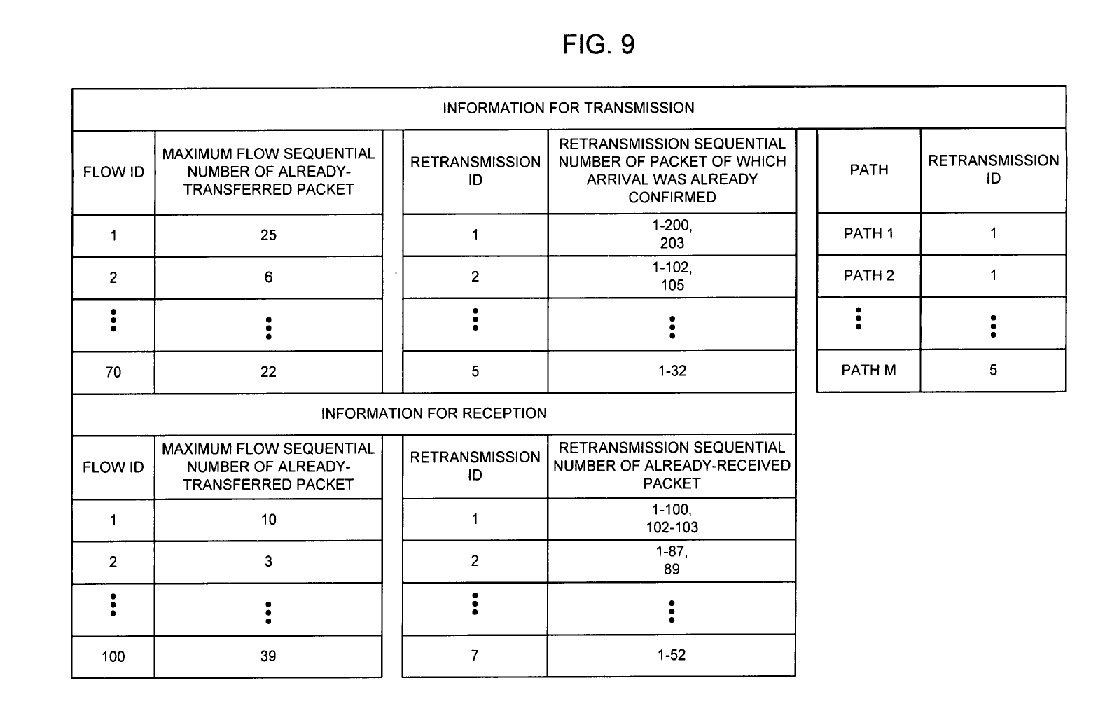

The above process allows the table part to be completed for making a mapping of the path and the retransmission ID shown in a table of FIG. 9. According hereto, the scheduler comes to decide the retransmission ID.

Also, in addition hereto, a method of making a mapping of the flow and the retransmission ID in a fixed manner, a method of making a mapping of one retransmission ID per path irrelevantly to information such as a delay and a delay dispersion are also considered.

### Embodiment 4

The foregoing embodiment 1, embodiment 2 and embodiment 3 premises that end-to-end communication is made between the transmitting and receiving nodes; however the present invention is also applicable to a case where many kinds of the end-to-end communication pass through two nodes without fail.

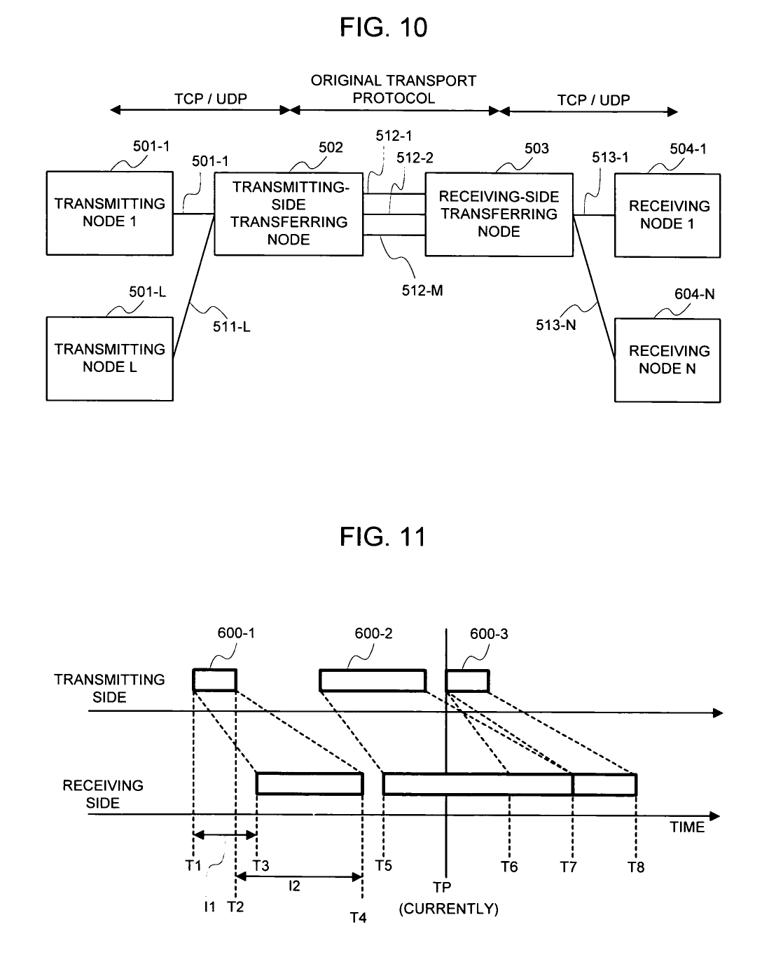

Upon making a reference of FIG. 10, the embodiment 4 is comprised of an arbitrary number of transmitting nodes 501-1 to 501-L, a transmitting-side transferring node 502, a receiving-side transferring node 503, an arbitrary number of receiving nodes 504-1 to 504-N, and they are linked as follows. Each transmitting node is connected to the transmitting-side transferring node via the paths 511-1 to 511-L respectively. The transmitting-side transferring node and the receiving-side transferring node are connected via a plurality of the paths, i.e. an arbitrary number (one or more) of the paths 512-1 to 512-M. Each receiving node is connected to the receiving-side transferring node via the paths 513-1 to 513-N respectively.

For example, in a case where the number of the paths between the transmitting-side transferring node and the receiving-side transferring node, i.e. M is 1, the embodiment 4 is similar to the embodiment 1.

Also, in a case where the number of the paths between the transmitting-side transferring node and the receiving-side transferring node, i.e. M is two or more, the embodiment 4 is similar to the embodiment 2 and the embodiment 3.

However, in the foregoing cases, the transmitting node in the embodiment 1, the embodiment 2, and the embodiment 3 becomes a transmitting-side transferring node, and likewise, the receiving node becomes a receiving-side transferring node. Also, the socket in the configuration within the transmitting-side transferring node becomes an inputting section of the packet to be received from the transmitting node, and the socket in the configuration within the receiving-side transferring node becomes an outputting section of the packet to be transmitted to the receiving node.

Also, in this case, the first group flow indicates a packet group that is decided in a one-to-one manner by means of the address/port number of the transmission source/destination of communication between each of the transmitting nodes 501-1 to 501-L and each of the receiving nodes 504-1 to 504-N.

The operation above allows the packet loss to be found out at an early stage, thus making it possible to make data transmission/reception between each of the transmitting nodes 501-1 to 501-L and each of the receiving nodes 504-1 to 504-N in a shorter time.

### Embodiment 5

The embodiment 5 of the present invention will be explained.

The embodiment 5 relates to a case where the schedulers 213 and 413 shown in the embodiment 2, embodiment 3, and the embodiment 4 perform a path selective operation according to a third criterion to be described below. This operation allows a frequency of retransmission caused by a sequential error to be reduced because a probability becomes high of receiving the packet in the receiving node in due sequence as expected by the transmitting node in a case where a plurality of the paths exist between the transmitting node and the receiving node. Also, in particular, applying the embodiment 5 for the configuration, in which a connection is made between the nodes made via a plurality of the paths like a case of the embodiment 3, or the embodiment 4, being an application thereof, allows the above-mentioned retransmitting control to be applied with more numerous communicating paths assumed to be one retransmission unit, whereby an improvement of a communication performance can be expected.

Herein, the so-called third criterion is a criterion of selecting the most appropriate path, for example, the path of which the arrival time is expected to be earliest, based upon the predicted arrival time or reception completion time of data.

For example, a transmission history of the transmission data (packet) is stored at the time of transmitting the data (packet). The identifier for identifying the transmission data (packet), the transmission start time, etc. are described in this transmission history. On the other hand, the receiving side transmits status information (for example, a speed or a packet delay) of the path through which the data (packet) passes to the transmitting side. Information for identifying the latest data (packet), for which the path status information is applied, like the identifier of the foregoing data (packet) is included in this path status information. The transmitting side receives status information of the path, and obtains the already-transmitted data (packet) for which this path status becomes available from the transmission history by means of information (for example, an identifier) for identifying the data (packet) included in this path status. And, it applies the received status of the path for the data subsequent to the obtained data (packet), thereby to predict the reception completion time etc. and further predicts the arrival time or the reception completion time of the data, which is to be transmitted to each path from now, based upon this prediction and the received status information of the path.

In the path selection, the most appropriate path, for example, the path of which the arrival time is predicted to be earliest is selected, based upon the predicted arrival time and the reception completion time of the data.

Herein, the so-called path status information points generally to information, which becomes an index of a communication performance. In this embodiment, out of these kinds of information, a speed and a packet delay of the path are employed. Also, the so-called time when the path status information becomes available, which does not signify the update time of the path status information on the transmitting-node side, is the time when the path status to be indicated by the path status information is yielded, the time specified by the packet transmitted in its path status, or the like. Accordingly, the so-called transmission history since the time when the path status information becomes available says a transmission history etc. of the packet transmitted since the time when the path status information becomes available. Additionally, this time is obtained from the packet information (identifier for identifying the packet) which becomes a foundation of its measurement, the reception time of the packet which is transmitted from the receiving-node side, or the like; however some shift does not matter. Also, in order to obtain the path status information, as to the method of measuring a speed or a delay by the receiving node, various kinds thereof have been provided; however the method, which is now considered, will be described below.

The transmitting node is for inserting the identifier and the transmission time into each of the packets to the receiving node to transfer it. The receiving node compares the transmission time inserted by the transmitting node with the time when the receiving nod itself received the packet, thereby to measure a packet delay. Also, the transmitting node transmits a packet row for measurement regularly, and the receiving node can infer a speed from a dispersion of its arrival time. The details of the method of drawing an inference was introduced, for example, in the document ┌Dovrolis, Ramanathan, and Moore, “what Do Packet Dispersion Techniques Measure?”, IEEE INFOCOM 2001┘. In the foregoing document of Dovrolis et al., the transmitting-side node transmits two packets simultaneously, and the transmitting side infers a link speed from a difference of the arrival time between these two packets. It is a transmission delay that spreads an arrival interval of the packet, and the transmission delay has a relation with the link speed, so the speed can be inferred from the arrival interval.

The receiving node transmits this measured value or the inferred value regularly as path status information to the transmitting node. Also, it transmits the identifier of the latest packet received until this time simultaneously as identification information of the packet for which the status information to be transmitted becomes available. These kinds of information are received as a report in the transmitting node. Additionally, the above-method technique is only one example, and a possibility as to whether the present invention is carried out does not depend upon the method of deciding and transferring the path status information and the packet for which this becomes available.

Hereinafter, a specific operation will be explained.

The scheduler 213 or 413 makes a reference to a report such as the path information received per transmission path until now, and the transmission history since transmission of the packet, for which its information becomes available, with the packet which should be transferred, thereby to predict the arrival delay in the receiving-side node. The transmission history has been stored in the memory section 216 or 416. The scheduler 213 or 413 selects the path of which the predicted arrival delay becomes least as a transmitting path of the packet, which should be transferred next, transfers the packet to the selected path, and thereafter adds its transfer time to the transmission history of the memory section 216 or 416.

As one example of a method of inferring the arrival delay per path operating in the scheduler 213 or 413, an operational example of the scheduler is shown in FIG. 11.

Each of 600-1, 600-2, and 600-3 of FIG. 11 is a data packet, the transmission history and the prediction in its transmitting-side node, and the reception history and the prediction in the receiving-side node are shown on a time axis. For example, the transmission of the data packet 600-1 starts at a time T1 in the transmitting-side node, and the transmission completes at a time T2. Also, the reception of the identical packet 600-1 starts at a time T3 in the receiving-side node, and the reception completes at a time T4. Herein, a difference I1 between T1 and T3 is a transmission delay. Also, a difference 12 between T4 and T2 is a total delay obtained by adding to the transmission delay I1 a dispersion of the packet to be generated due to a speed difference between the transmitting interface and the transferring path.

Herein, at a current time of TP on the time axis, it is assumed that the packet 600-3 is to be transmitted. And, it is assumed that with this path, the path status information, which the transmitting side node has, is updated by receiving the report result notification between T5 and TP and that this path status information becomes available for the packet 600-1 and a packet subsequent hereto. Thereupon, based upon the transmission history of the packets 600-1 and 600-2 for which the path status information becomes available, an inference is drawn of the reception completion time of the packet 600-3 having the packets 600-1 and 600-2 considered.

Whereupon, the reception start time and completion time in the receiving-side node of the packet 600-2 transmitted after the packet 600-1 can be inferred from the speed and the transmission delay to be included in the path status information, which is currently being received. The inferred reception start time is T5 in FIG. 11 and the reception completion time is T7. Herein, without drawing this inference, assuming that the transmission delay, which the path status information represents, is equal to I1, the reception of the packet 600-3 of which the transmission started at TP ought to start at a time T6. However, at T6, even now in the receiving-side node, it is inferred that the reception of the packet 600-2 has not been completed, so the reception time of the packet 600-3 is assumed to start at and after T7 when the reception of the packet 600-2 is inferred to complete, and the inferred reception completion time of the packet 600-3 is T8 obtained by adding the packet dispersion to be inferred from the path speed to be included in the path status information, which is currently been received. Likewise, an inference is drawn of the reception completion time of the packet 600-3 for each path, and the packet 600-3 is sent out to the path of which the reception completion time is earliest.

Additionally, the path status information, which is employed for inferring the arrival time on the receiving side at a time point of TP in FIG. 11, is information updated by the reception of the report result notification between T5 and TP. Whereupon, it follows that an inference was drawn of the arrival time at the moment of having transmitted the packet 600-2, based upon the path status information older than the path status information at TP. Assuming that this old status information is information A and the new information updated between T5 and TP is information B respectively, the arrival time prediction based upon A ought to have been different from the arrival time prediction based upon B shown in FIG. 11 if the delays and the path speeds to be included in the information A and the information B differ due to a fluctuation of the link status. Accordingly, so as to draw a more accurate inference, the arrival time prediction of the packets 600-1 and 600-2 shown in FIG. 11 has reflected a modification as a result of having obtained the information B. Once the path status information is updated, it is becomes unnecessary to make a reference to the transmission history prior to the packet for which its update becomes available, so it is destroyed.

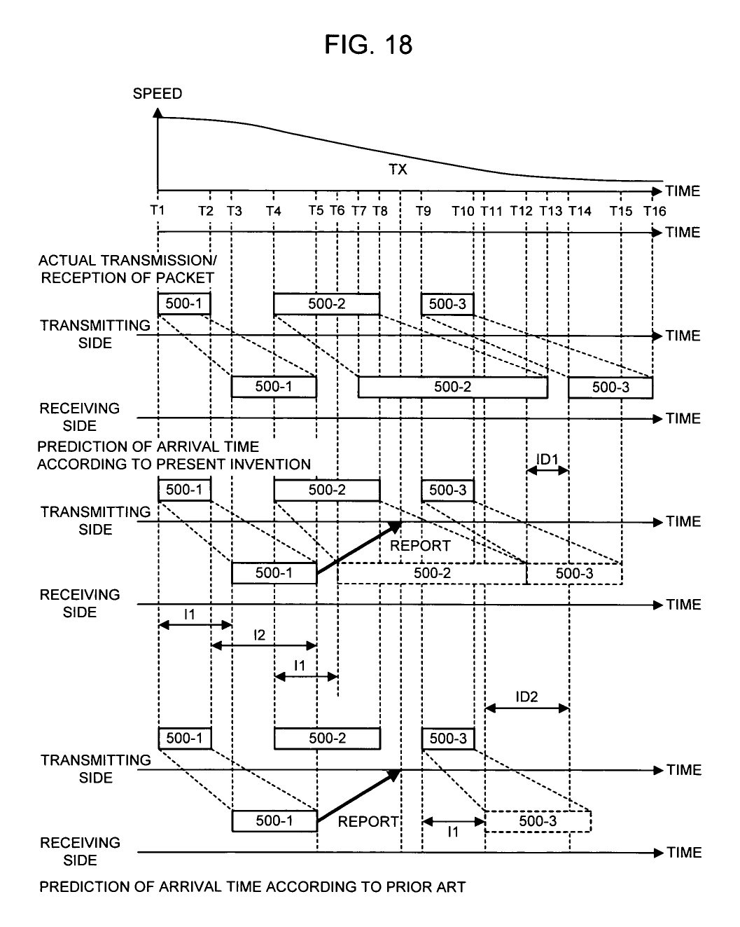

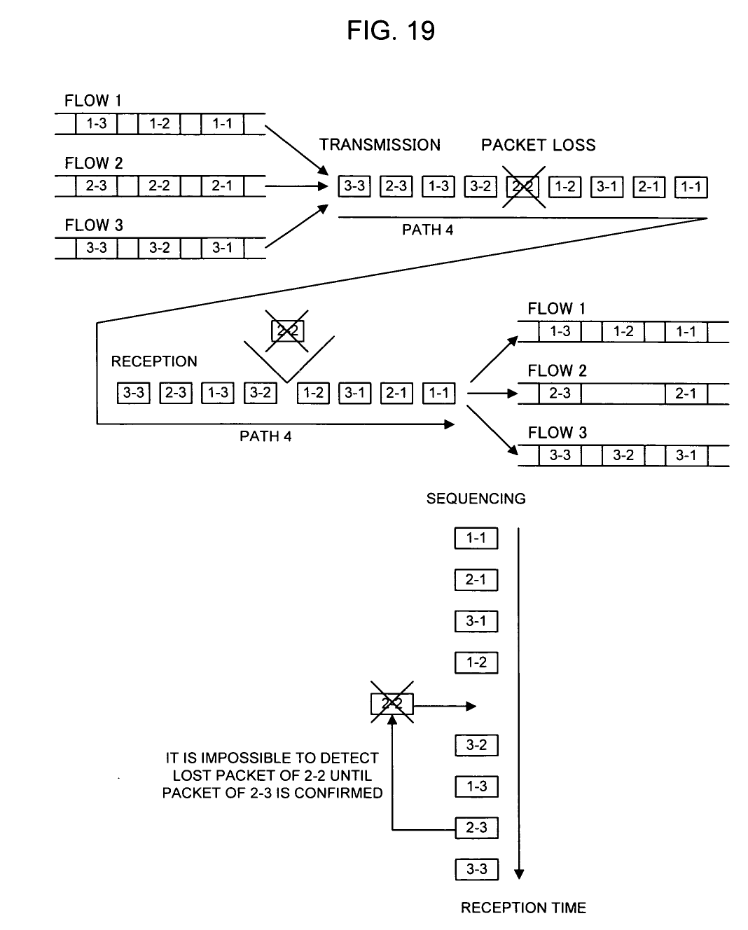

Further, a difference between the packet arrival time inference in a case where the present invention applied and the conventional packet arrival time inference, and a difference between the reception completion time in a case where the present invention applied and the conventional reception completion time will be explained specifically, by employing FIG. 18.

Each of 500-1, 500-2, and 500-3 of FIG. 18 is a data packet to be sent out, and the transmission history (solid line) of the packet in its transmitting-side node and the actual reception history (solid line) of the packet in the receiving-side node are shown on the time axis respectively. Also, the prediction (dotted line) of the arrival time and the reception completion time of the packet are shown on the time axis respectively. Also, the curve described in the upper part of FIG. 18 is for showing a change in a speed of the transmission path. FIG. 18 shows the effect that the transmission speed becomes slow as the time lapses.

At first, speaking of the actual transmission/reception of the packet, the transmission of the data packet 500-1 starts at a time T1 from the transmitting-side node, and the transmission completes at a time T2. And, in the receiving-side node, the reception of the data packet 500-1 starts at a time T3, and the reception completes at a time T5.

Thereafter, the transmission of the data packet 500-2 starts at a time T4 from the transmitting-side node, and the transmission completes at a time T8. And, in the receiving-side node, the reception of the data packet 500-2 starts at a time T7 due to a decline in a communication speed, and the reception completes at a time T13.

Further, the transmission of the data packet 500-3 starts at a time T9 from the transmitting-side node, and the transmission completes at a time T10. And, in the receiving-side node, the reception of the data packet 500-3 starts at a time T14, and the reception completes at a time T16.

Next, in the actual transmission/reception of the packet as described above, a prediction will be explained of the arrival time and the reception completion time of the packet in a cased where the present invention applied.

As described above, transmitting the data packet 500-1 together with the transmission time of the data packet 500-1 and the information of the packet identifier starts at a time T1 in the transmitting-side node, and the transmission completes at a time T2. At this time, in the transmitting-side node, the transmission time and the packet identifier of the data packet 500-1 have been stored as a transmission history.

Continuously, transmitting the data packet 500-2 together with the transmission time of the data packet 500-2 and the information of the packet identifier by the transmitting-side node starts at a time T4 in the transmitting-side node, and the transmission completes at a time T8. At this time, in the transmitting-side node, similarly to the foregoing, the transmission time and the packet identifier of the data packet 500-2 have been stored as a transmission history.

In the receiving-side node, the reception of the data packet 500-1 starts at a time T3, and the reception completes at a time T5. At this time, the receiving-node node transmits information such as the identifier of the data packet 500-1, the reception completion time and the communication speed as a report to the transmitting node.

On the transmitting-node side, it is assumed that the report was received from the receiving node at a time TX. And, it is determined from the identifier of the data packet 500-1 to be included in the report that the time when the path status information of the report becomes available is the transmission time T1 of the data packet 500-1.

Thereupon, the transmitting node makes a prediction of the arrival time and the reception completion time of the data packet 500-3, based upon the transmission history since the time T1. The transmission history since the time T1 says that it is the data packet 500-1 and the data packet 500-2 that become an object. It is seen from the report that the reception completion time of the data packet 500-1 is the time T5. For predicting the arrival time and the reception completion time of the data packet 500-2, the communication speed and the reception completion time of the data packet 500-1 of the report are employed, and the transmission delay and the total delay time of the packet are seen from these kinds of information. Additionally, the transmission delay is a difference I1 between T1 and T3. Also, the total delay of the packet, which is a time obtained by adding to the transmission delay I1 a dispersion of the packet produced due to a speed difference between the transmitting interface and the transferring path, is a difference 12 between T5 and T2. The arrival time of the data packet 500-2, which is obtained from the transmission delay I1, is predicted to be a time T6 obtained by adding the transmission delay I1 to the transmission time T4 of the data packet 500-2. Also, it can be predicted that reception completion time of the data packet 500-2 is a time T12 because the packet delay can be obtained with the communication speed of the report. Accordingly, with this path, it can be predicted that the arrival time of the data packet 500-3 to the receiving node starts at and after a time T12. Also, it can be predicted by predicting the foregoing packet dispersion that the reception completion time in a case where the reception started at this time T12 is a time T15. Such a predicted result demonstrates that a difference is a time ID1 between the predicted arrival time T12 of the data packet 500-3 and the actual arrival time T14 of the data packet 500-3.

On the other hand, in the prediction of the arrival time and the reception completion time of the packet by means of the prior art, at the arrival time of the report obtained from the receiving node, the path status to be shown in the report is assumed to be available, and also in the prediction of the data packet 500-3, the path status to be shown in the report applies as it stands. That is, in the prediction of the arrival time of the data packet 500-3, it is predicted that its arrival time is a time T11 obtained by adding the transmission delay I1 to the transmission time T9 of the data packet 500-3. Such a predicted result demonstrates that a difference is a time ID2 between the predicted arrival time T11 of the data packet 500-3 and the actual arrival time T14 of the data packet 500-3.

Accordingly, as to the error time ID1 and the error time ID2 with the actual arrival time, it is apparent from the accompanied drawings that the error time ID1 by the prediction in accordance with the present invention is smaller than the error time ID2.

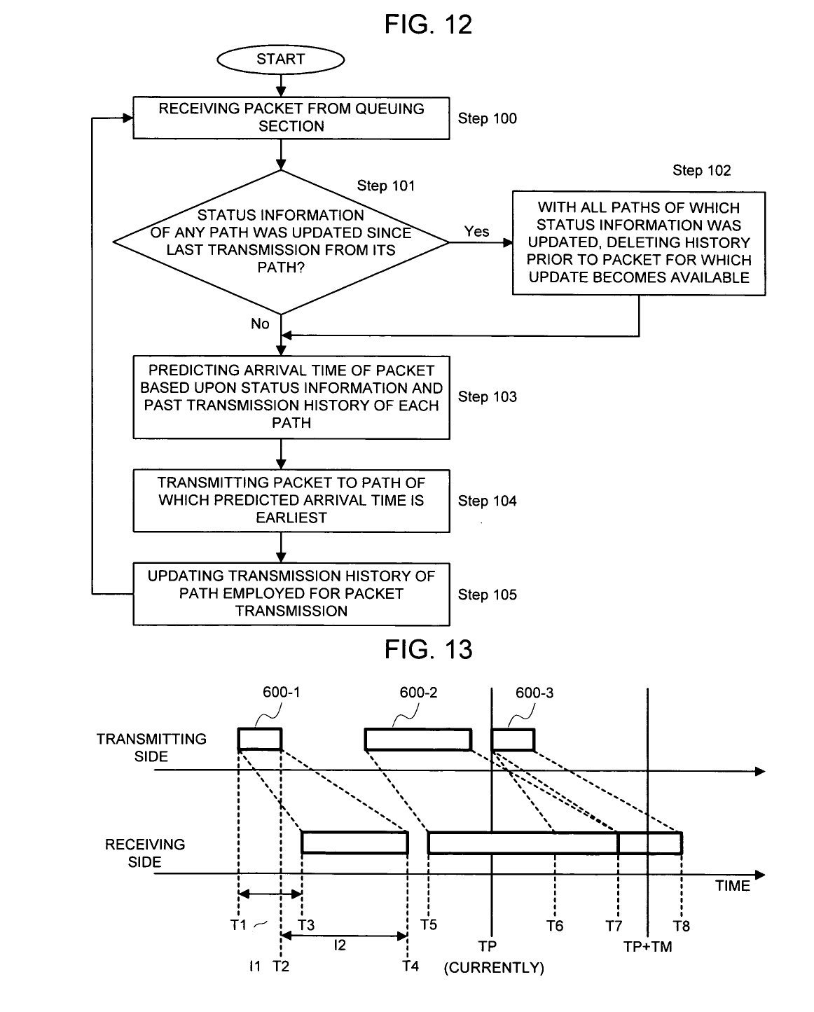

Next, a procedure of the path selection of the scheduler including the arrival time inference as explained above is shown in FIG. 12.

At first, by a queuing section 312, the packet is received (Step 100).

Next, with any path, it is determined whether the path status information was updated after the last packet was transmitted from its path (Step 101). In a case where the path status information was updated, with all updated paths, the transmission history prior to the time when the path status information becomes available is deleted (Step 102).

Continuously, with each path, a prediction (an inference) is made of the arrival time of the packet, based upon the path status information and the transmission history (step 103). And, the packet is transmitted to the path of which the predicted (inferred) arrival time is earliest (Step 104).

Finally, the transmission history is updated of the path employed for the packet transmission (Step 105).

As mentioned above, in updating the path status information, a prediction of the arrival time of the packet already transmitted prior to updating is modified, which is reflected in a determination at the moment of transmitting the subsequent packet, whereby a compensation for the past transmission records is made possible resultingly. An effect of this compensation becomes remarkable in a case where a round-trip delay of each path is large and is not able to be neglected as against a period of the status fluctuation of the path. Its reason will be described below.

In a case where the status fluctuation of the path occurs during the time of a round-trip delay or something like it, at the time point that the transmitting-side node acquired some status information, the status of the above path might have already been changed, so its information is untrustworthy. Accordingly, it is impossible to make path selection and a timing setting most suitably at the time point of transmitting the packet, and it follows that the packet is generally transmitted with the at non-suitable path and at a non-suitable timing. A modification of the arrival time prediction in updating the status information is equal to drawing an inference of an impact of the non-suitable transmission, which was already made, after the time passes by a time equivalent to an interval of updating the status information. For example, in a case where the packet was previously transmitted at a too high rate, the arrival prediction time of the already-transmitted packet is prolonged due to updating the status information, and the transmission cost of its path is raised.

A modification of the arrival time prediction of the past transmission packet accompanied by updating the status information, as mentioned above, has an effect upon optimization of the path selection, and in addition to the path selection, feeding a modification of the arrival time prediction back to the transmission timing control allows a congestion control of each path to be also optimized in a long term.

Next, other embodiment for carrying out the invention will be explained.

In the embodiment below, an operation is explained of a case where a simple timing control was mounted.

In another embodiment shown next, similarly to the foregoing embodiments, the reception completion time of transmission packet is inferred path by path, and the rout of which the evaluated value is highest is selected; however an allowable inference delay can be newly defined path by path to introduce a simple timing control such that the transmitting-side node controls the transmission timing so that the inferred delay does not exceed its allowable value. An operation of this embodiment will be explained, by employing FIG. 13.

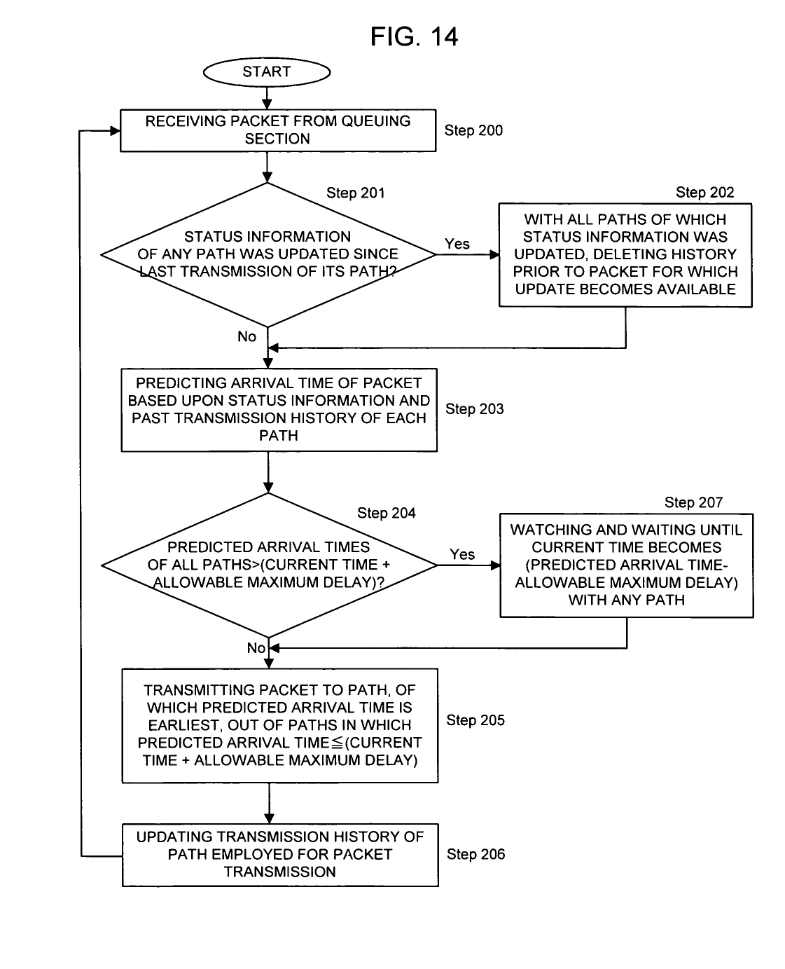

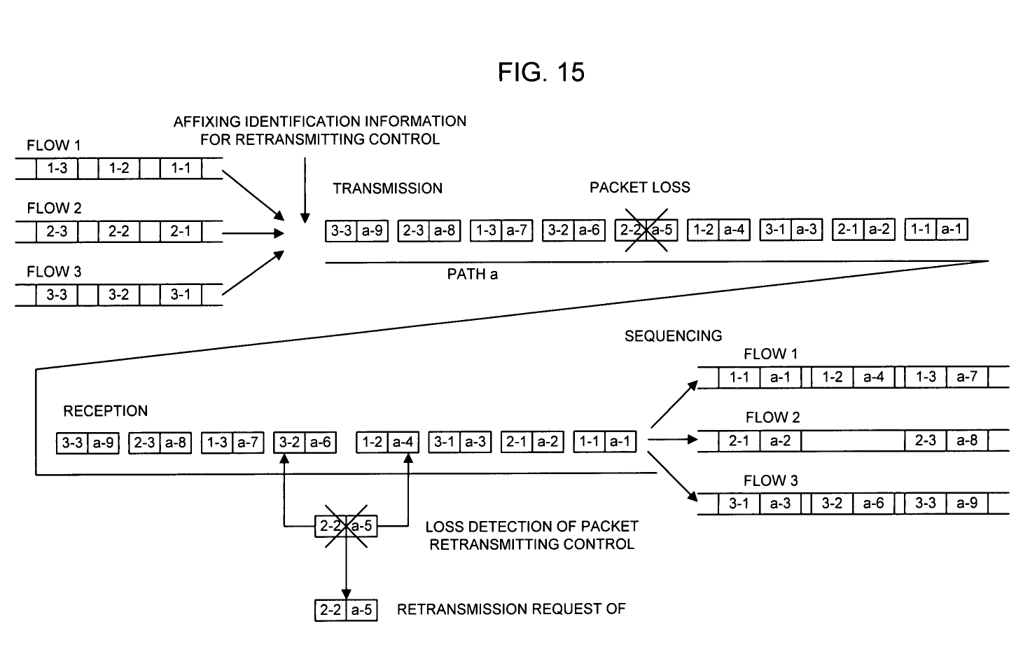

In FIG. 13, assuming that the allowable inference delay is TM. This meaning is that transmitting the packet at the time point of TP necessitates an inference that the reception of its packet will complete until TM+TP. As it is, drawing an inference of the reception completion time of the packet 400-3 with a means similar to the foregoing embodiments shows that it is T8, and this is a future time as against TM+TP. Accordingly, until the inferred reception completion time of TM+TP is yielded, the transmitting node 100 can not transmit the packet 400-3 from this path. In this case, the transmitting-side node 100 reserves the packet 400-3 until the inferred reception completion time of TM+TP or less is yielded with any path, and transmits this packet from the path of which reservation is cleared earliest. An operation of the scheduling in the above embodiment is shown in FIG. 14.

At first, by the queuing section 312, the packet is received (Step 200).

Next, with any path, it is determined whether the path status information was updated after the last packet was transmitted from its path (Step 201). In a case where the path status information was updated, with all updated paths, the transmission history prior to the time when the path status information becomes available is deleted (Step 202).

Continuously, with each path, a prediction (an inference) is made of the arrival time of the packet, based upon the path status information and the transmission history (step 203). And, by employing the predicted (inferred) arrival time, with all paths, it is determined whether (predicted (inferred) arrival time)>(current time+allowable inference delay) (step 204), and with any path, in a case of (predicted (inferred) arrival time)≦(current time+allowable inference delay), the packet is transmitted to the path of which the predicted (inferred) arrival time is earliest, out of these paths (Step 205).

On the other hand, with all paths, in a case of (predicted (inferred) arrival time)>(current time+allowable inference delay), the operation watches and waits until the current time becomes (predicted arrival time-allowable inference delay) with any path, and in a case where the condition is met with any path, the operation proceeds to the Step 205 (Step 206)

Finally, the transmission history is updated of the path employed for the packet transmission (Step 207).

Additionally, the value of the allowable delay TM may be set path by path independently. For example, in a case where a delay of each path, the buffer quantity of a server, which passes through the path, or the like is different largely, particularly, under a high load, it is thought that making a setting so that a setting value of the TM of each path differs from that of the other allows a practical use of the band of each path to be realized effectively.

Also, as to the determination of the path selection, in addition to the inferred reception completion time, for example, a packet missing ratio, a circuit fee, etc. may be evaluated on a priority basis as far as they can be monitored. Also, how to make a determination may differ depending upon attribute of data to be sent. For example, with the audio data, selection is made of attaching importance to a delay, and with the file transfer data that is not urgent, selection is made of attaching importance to a circuit fee, respectively. The characteristic of the present invention is that in any case, when the transmitting node updates the path status information, simultaneously it acquires the transmission packet for which its update becomes available or the time when it does, infers an impact upon the transmission cost from the transmission history since the packet for which the update becomes available or the time when it does, and transmits the next packet to the path of which the cost is least. As a result, also in a case where a delay is large, i.e. is too large to be neglected as compared with a time constant of the status fluctuation of the path, reflecting an impact upon the cost standard already given by the past non-suitable transmission into an adjustment of the subsequent transmission timing allows its impact to be compensated, which has an effect upon an improvement in a utilization efficiency of the path.

Additionally, in the foregoing embodiment 1, embodiment 2, embodiment 3, embodiment 4, and embodiment 5, the flow identifying sections 211 and 222, the scheduler 213, the retransmission controlling section 214, the retransmission ID sequence checking section 221, the flow sequence check section 223, etc. of the node were configured as a separate section respectively; however a whole or one part thereof may be configured with a CPU etc. operating under a controlling program.

1. A method of communication between a transmitting node and a receiving node, characterized in that:
the transmitting node provides a first group flow having one flow or more based upon a first criterion relating to a sequencing and a second group flow having one flow or more based upon a second criterion relating to a retransmitting control, assigns a first identifier to each flow belonging to said first group flow, said first identifier being unique, and assigns a second identifier to each flow belonging to said second group flow, said second identifier being unique; and
the transmitting node classifies the packets, which were input, into one flow or more belonging to said first group flow, based upon said first criterion, yet classifies them into one flow or more belonging to said second group flow, based upon said second criterion, affixes to said packets said first identifier, a first sequential number, said first sequential number being unique within flows specified by said first identifier, said second identifier, a second sequential number, said second sequential number being unique within flows specified by said second identifier, and transmit them;
the receiving node classifies all received packets based upon the second identifier, and checks the packets having the second sequential number, which were not received, with each second group flow, and requests the transmitting node of retransmission thereof;
the transmitting node retransmits the packets of the second group flow having the second sequential number requested by the receiving node; and
the receiving node classifies all received packets based upon the first identifier, sequences the packets within each first group flow based upon the first sequential number, and performs a receiving process of the sequenced packets in the sequenced order.

2. The communication method according to claim 1, characterized in that the transmitting node and the receiving node are connected via one communicating path, the second group flow of the transmitting node is comprised of a single flow, and the packets are transmitted by utilizing a single communicating path.

3. The communication method according to claim 1, characterized in that in a case where a plurality of communicating paths for transmitting the packet exist, the transmitting node selects the communicating path for transmitting the packet, based upon a third criterion relating to a schedule of the packet transmission.

4. The communication method according to claim 3, characterized in that the transmitting node and the receiving node are connected via a plurality of communicating paths, and the transmitting node classifies the packets into unique flows corresponding to the communicating paths, through which the packets to be transmitted pass, as a second criterion, and selects the communicating path in retransmitting the packets independently of the communicating path selected at the time of the first transmission as a third criterion.

5. The communication method according to claim 3, characterized in that the transmitting node and the receiving node are connected via a plurality of communicating paths, and the transmitting node classifies the packets into the flows of which the number is fewer than the number of the communicating paths, through which the packets to be transmitted pass, as a second criterion, and selects the communicating path in retransmitting the packets independently of the communicating path selected at the time of the first transmission as a third criterion.

6. The communication method according to claim 1, characterized in that the transmitting node is a transmitting-side transferring node for transferring the packet, transmitted by a separate communicating node, and the receiving node is a receiving-side transferring node for transferring the packet, received by a separate communicating node.

7. The communication method according to claim 6, characterized in that the transmitting node and the receiving node are connected via one communicating path, the second group flow of the transmitting node is comprised of a single flow, and the packets are transmitted by utilizing a single communicating path.

8. The communication method according to claim 6, characterized in that the transmitting node and the receiving node are connected via a plurality of communicating paths, and the transmitting node classifies the packets into unique flows corresponding to the communicating paths, through which the packets to be transmitted pass, as a second criterion, and selects the communicating path in retransmitting the packets independently of the communicating path selected at the time of the first transmission as a third criterion.

9. The communication method according to claim 6, characterized in that the transmitting node and the receiving node are connected via a plurality of communicating paths, and the transmitting node classifies the packets into the flows of which the number is fewer than the number of the communicating paths, through which the packets to be transmitted pass, as a second criterion, and selects the communicating path in retransmitting the packets independently of the communicating path selected at the time of the first transmission as a third criterion.

10. The communication method according to claim 3, characterized in that selection of the path or a decision of a selection priority thereof is made in the transmitting node as a third criterion of the transmitting node, where path selection or path selection priority update is performed upon every packet to be input, based on path status information on a selectable path, based on identification information on a time from which said path status information is effective or on a transmitted packet, and based on a transmission history after the time from which said path status information is effective or a transmission history after transmission of the packet specified with transmitted packet identification information.

11. The communication method according to claim 10, wherein said path status information includes a delay of a path.

12. The communication method according to claim 10, wherein said path status information includes a transmission rate of a path.

13. The communication method according to claim 10, wherein said path status information includes a load of a path.

14. The communication method according to claim 10, further comprising the step of correcting a transmission cost calculation result regarding a packet transmitted before updating path status information of each path, when the path status information is updated for path selection or selection priority update.

15. The communication method according to claim 14, further comprising the step of discarding a history prior to a first packet transmitted on or after a time from which the latest path status information is effective, when a transmission cost calculation result of each path is corrected.

16. The communication method according to claim 10, further comprising the step of selecting as a packet transmission path a path having an earliest estimation value of a reception completion time at a reception node.

17. The communication method according to claim 10, further comprising the step of selecting as a packet transmission path a path having a largest estimation value of a data amount, which can be completely received by a specific time at a reception node.

18. The communication method according to claim 10, further the step of interrupting data transmission according to an estimated current path status in each path.

19. The communication method according to claim 18, wherein a condition for interruption of said data transmission is that an estimated reception completion time is equal to or greater than a specific value.

20. The communication method according to claim 10, characterized in that path selection or a determination of a transmission interruption is made according to the policy, which differs every attribution of transmission data.

21. A node, said node being configured of a transmitting section for transmitting a packet and a receiving section for receiving the packet and taking a retransmitting control and a sequencing of the packet independently, characterized in that:
said transmitting section includes:
a means for affixing to the transmission packet a first identifier, said first identifier being assigned in a one-to-one manner to each flow of a first group flow based upon a first criterion relating to a sequencing, a first sequential number, said first sequential number being unique within each flow belonging to said first group flow, a second identifier, said second identifier being assigned in a one-to-one manner to each flow of a second group flow based upon a second criterion relating to a retransmitting control, and a second sequential number, said second sequential number being unique within each flow belonging to said second group flow, to transmit it; and
a means for specifying the packet, for which retransmission was requested by the node having received the packet, from said second identifier and second sequential number to retransmit its packet: and that
said receiving section includes:
a means for classifying all received packets based upon said second identifier to check the packets having the second sequential number, which were not received, with each second group flow to transmit its second identifier and second sequential number to the node having transmitted the packet, and to request retransmission thereof; and
a means for classifying all received packets based upon said first identifier to sequence the packets within each first group flow based upon said first sequential number to perform a receiving process of the sequenced packets in the sequenced order.

22. The node according to claim 21, characterized in that each of nodes is connected to the other via one communicating path, the second group flow is comprised of a single flow, and the packet is transmitted by utilizing a single communicating path.

23. The node according to claim 21, characterized in, in a case where a plurality of communicating paths for transmitting the packet exist, including a means for selecting the communicating path for transmitting the packet, based upon a third criterion relating to a schedule of the packet transmission.

24. The node according to claim 23, characterized in that each of the nodes is connected to the other via a plurality of communicating paths, and the packets are classified into unique flows corresponding to the communicating paths, through which the packets to be transmitted pass, as a second criterion, and the communicating path is selected in retransmitting the packets independently of the communicating path selected at the time of the first transmission as a third criterion.

25. The node according to claim 23, characterized in that, each of the nodes is connected to the other via a plurality of communicating paths, the packets are classified into the flows of which the number is fewer than the number of the communicating paths, through which the packets to be transmitted pass, as a second criterion, and the communicating path is selected in retransmitting the packets independently of the communicating path selected at the time of the first transmission as a third criterion.

26. The node according to claim 21, characterized in that the transmitting section of the node is a transferring-side transferring node for transferring the packet transmitted by a separate communicating node, and the receiving section of the node is a receiving-side transferring node for transferring the packet received by a separate communicating node.

27. The node according to claim 26, characterized in that each of the nodes is connected to the other via one communicating path, the second group flow is comprised of a single flow, and the packets are transmitted by utilizing a single communicating path.

28. The node according to claim 26, characterized in that each of the nodes is connected to the other via a plurality of communicating paths, the packets are classified into unique flows corresponding to the communicating path, through which the packets to be transmitted pass, as a second criterion, and the communicating path is selected in retransmitting the packets independently of the communicating path selected at the time of the first transmission as a third criterion.

29. The node according to claim 26, characterized in that each of the nodes is connected to the other via a plurality of communicating paths, the packets are classified into the flows of which the number is fewer than the number of the communicating paths, through which the packets to be transmitted pass, as a second criterion, and the communicating path is selected in retransmitting the packets independently of the communicating path selected at the time of the first transmission as a third criterion.

30. The node according to claim 23, wherein said means for selecting the communicating path makes selection of the path or a decision of a selection priority thereof is made in the transmitting node as a third criterion, where path selection or path selection priority update is performed upon every packet to be input, based on path status information on a selectable path, based on identification information on a time from which said path status information is effective or on a transmitted packet, and based on a transmission history after the time from which said path status information is effective or a transmission history after transmission of the packet specified with transmitted packet identification information.

31. The node according to claim 30, wherein said path status information includes a delay of a path.

32. The node according to claim 30, wherein said path status information includes a transmission rate of a path.

33. The node according to claim 30, wherein said path status information includes a load of a path.

34. The node according to claim 30, wherein said means for selecting the communicating path corrects a transmission cost calculation result regarding a packet transmitted prior or updating when path status information of each path is updated in the updating of path selection or selection priority.

35. The node according to claim 34, wherein said means for selecting the communicating path discards a history before a first transmitted packet validating latest path status information when a transmission cost calculation result of each path is corrected.

36. The node according to claim 30, wherein said means for selecting the communicating path selects as a packet transmission path a path having an earliest estimation value of a reception completion time at a reception node.

37. The node according to claim 30, wherein said means for selecting the communicating path selects as a packet transmission path a path having a largest estimation value of a data amount which can be completely received by a specific time at a reception node.

38. The node according to claim 30, wherein said means for selecting the communicating path interrupts data transmission according to an estimated current path status for each path.

39. The node according to claim 38, wherein a condition for interruption of said data transmission is that an estimated reception completion time is equal to or greater than a specific value.

40. The node according to claim 30, wherein said means for selecting the communicating path determines the interruption of path selection or transmission according to a policy different every attribute of a transmission data.

41. A controlling program for a node, said node taking a retransmitting control and a sequencing of a packet independently, characterized in that said controlling program causes said node to function as:
a means for affixing to the transmission packet a first identifier, said first identifier being assigned in a one-to-one manner to each flow of a first group flow based upon a first criterion relating to a sequencing, a first sequential number, said first sequential number being unique within each flow belonging to said first group flow, a second identifier, said second identifier being assigned in a one-to-one manner to each flow of a second group flow based upon a second criterion relating to a retransmitting control, and a second sequential number, said second sequential number being unique within each flow belonging to said second group flow, to transmit it;
a means for specifying the packet, for which retransmission was requested by the node having received the packet, from said second identifier and second sequential number to retransmit its packet;
a means for classifying all received packets based upon said second identifier to check the packets having the second sequential number, which were not received, with each second group flow to transmit its second identifier and second sequential number to the node having transmitted the packet, and to request retransmission thereof; and
a means for classifying all received packets based upon said first identifier to sequence the packets based upon said first sequential number with each first group flow, and to perform a receiving process of the sequenced packets in the sequenced order.

42. The controlling program for a node according to claim 41, characterized in each of nodes is connected to the other via one communicating path, the second group flow is comprised of a single flow, and the packet is transmitted by utilizing a single communicating path.

43. The controlling program for a node according to claim 41, characterized in, in a case where a plurality of communicating paths for transmitting the packet exist, causing said node to function as a means for selecting the communicating path for transmitting the packet based upon a third criterion relating to a schedule of the packet transmission.

44. The controlling program for a node according to claim 43, characterized in each of the nodes is connected to the other via a plurality of communicating paths, and the packets are classified into unique flows corresponding to the communicating paths, through which the packets to be transmitted pass, as a second criterion, and the communicating path is selected in retransmitting the packets independently of the communicating path selected at the time of the first transmission as a third criterion.

45. The controlling program for a node according to claim 43, characterized in that each of the nodes is connected to the other via a plurality of communicating paths, the packets are classified into the flows of which the number is fewer than the number of the communicating paths, through which the packets to be transmitted pass, as a second criterion, and the communicating path is selected in retransmitting the packets independently of the communicating path selected at the time of the first transmission as a third criterion.

46. The controlling program for a node according to claim 41, characterized in that the transmitting section of the node is a transmitting-side transferring node for transferring the packet, transmitted by a separate communicating node, and the receiving section of the node is a receiving-side transferring node for transferring the packet, received by a separate communicating node.

47. The controlling program for a node according to claim 46, characterized in that each of the nodes is connected to the other via one communicating path, the second group flow is comprised of a single flow, and the packets are transmitted by utilizing a single communicating path.

48. The controlling program for a node according to claim 46, characterized in that each of the nodes is connected to the other via a plurality of communicating paths, the packets are classified into unique flows corresponding to the communicating paths, through which the packets to be transmitted pass, as a second criterion, and the communicating path is selected in retransmitting the packets independently of the communicating path selected at the time of the first transmission as a third criterion.

49. The controlling program for a node according to claim 46, characterized in that each of the nodes is connected to the other via a plurality of communicating paths, the packets are classified into the flows of which the number is fewer than the number of the communicating paths, through which the packets to be transmitted pass, as a second criterion, and the communicating path is selected in retransmitting the packets independently of the communicating path selected at the time of the first transmission as a third criterion.

50. The controlling program for a node according to claim 43, characterized in causing said means for selecting the communicating path to make selection of the path or a decision of a selection priority thereof is made in the transmitting node as a third criterion, where path selection or path selection priority update is performed upon every packet to be input, based on path status information on a selectable path, based on identification information on a time from which said path status information is effective or on a transmitted packet, and based on a transmission history after the time from which said path status information is effective or a transmission history after transmission of the packet specified with transmitted packet identification information.

51. The controlling program for a node according to claim 50, wherein said path status information includes a delay of a path.

52. The controlling program for a node according to claim 50, wherein said path status information includes a transmission rate of a path.

53. The controlling program for a node according to claim 50, wherein said path status information includes a load of a path.

54. The controlling program for a node according to claim 50, further controlling said means for selecting the communicating path so as to correct a transmission cost calculation result regarding a packet transmitted prior or updating when path status information of each path is updated in the updating of path selection or selection priority.

55. The controlling program for a node according to claim 54, further controlling said means for selecting the communicating path so as to discard a history before a first transmitted packet validating latest path status information when a transmission cost calculation result of each path is corrected.

56. The controlling program for a node according to claim 50, further controlling said means for selecting the communicating path so as to select as a packet transmission path a path having an earliest estimation value of a reception completion time at a reception node.

57. The controlling program for a node according to claim 50, further controlling said means for selecting the communicating path so as to select as a packet transmission path a path having a largest estimation value of a data amount which can be completely received by a specific time at a reception node.

58. The controlling program for a node according to claim 50, further controlling said means for selecting the communicating path so as to interrupt data transmission according to an estimated current path status for each path.

59. The controlling program for a node according to claim 58, wherein a condition for interruption of said data transmission is that an estimated reception completion time is equal to or greater than a specific value.

60. The controlling program for a node according to claim 50, further controlling said means for selecting the communicating path so as to determine path selection or transmission interruption according to a policy different every attribute of transmission data.

61. A communicating method, characterized in affixing an identifier for identifying a transmission flow and a sequential number within said transmission flow to a communication packet in addition to information for a sequencing to take a retransmitting control thereof per transmission flow on the receiving side, based upon said identifier and said sequential number.

62. A communicating method, characterized in affixing an identifier for identifying a transmission flow and a sequential number within said transmission flow to a communication packet in addition to information for a sequencing to detect a loss of the packet per transmission flow on the receiving side, based upon said identifier and said sequential number.

63. A node, characterized in including:
a means for affixing to the packet a first identifier, said first identifier being assigned in a one-to-one manner to each flow of a first group flow based upon a first criterion relating to a sequencing, a first sequential number, said first sequential number being unique within each flow belonging to said first group flow, a second identifier, said second identifier being assigned in a one-to-one manner to each flow of a second group flow based upon a second criterion relating to a retransmitting control, and a second sequential number, said second sequential number being unique within each flow belonging to said second group flow, to transmit it; and
a means for retransmitting the lost packets, which were detected, per transmission flow based upon said second identifier and said second sequential number.

64. A controlling program of a node, characterized in causing said node to function as:
a means for affixing to the packet a first identifier, said first identifier being assigned in a one-to-one manner to each flow of a first group flow based upon a first criterion relating to a sequencing, a first sequential number, said first sequential number being unique within each flow belonging to said first group flow, a second identifier, said second identifier being assigned in a one-to-one manner to each flow of a second group flow based upon a second criterion relating to a retransmitting control, and a second sequential number, said second sequential number being unique within each flow belonging to said second group flow, to transmit it; and
a means for retransmitting the lost packets, which were detected, per transmission flow based upon said second identifier and said second sequential number.
